(19) United States
(12) Patent Application Publication
(10) Pub. No.: US 2010/0132263 A1
(43) Pub. Date: Jun. 3, 2010

(54) INTEGRATED TILT LATCH AND SASH LOCK ASSEMBLY

(75) Inventor: Edward C. Flory, Crown Point, IN (US)

Correspondence Address: BANNER & WITCOFF, LTD., TEN SOUTH WACKER DRIVE, SUITE 3000, CHICAGO, IL, 60606, US

(73) Assignee: NEWELL OPERATING COMPANY, Atlanta, GA (US)

(21) Appl. No.: 12/603,292

(22) Filed: Oct. 21, 2009

Related U.S. Application Data
(60) Provisional application No. 61/107,072, filed on Oct. 21, 2008.

(51) Int. Cl. E05C 9/14; E05C 5/02; E05C 9/02; E05C 9/08; E05C 9/10; E05B 65/00; E05C 19/00

(52) U.S. Cl. 49/395; 292/4; 49/394

(57) ABSTRACT

An integrated tilt latch and sash lock assembly is suitable for use with a sash window assembly, and includes a sash lock mechanism, two tilt latch mechanisms, two connectors, and a drive mechanism engaging the connectors. The sash lock mechanism includes a handle and a rotor that is rotatable by movement of the handle. The tilt latch mechanisms each include a latch bolt moveable between an extended position and a retracted position. The first connector is operably connected to the rotor and to the latch bolt of the first tilt latch mechanism, and the second connector is operably connected to the latch bolt of the second tilt-latch mechanism. Movement of the first connector activates the drive mechanism, and activation of the drive mechanism creates reciprocal movement of the second connector to retract both latch bolts when the rotor is moved to the tiltable position.

### CROSS-REFERENCE TO RELATED APPLICATIONS

The present application is a continuation-in-part of and claims the benefit of U.S. Provisional Patent Application No. 61/107,072, filed on Oct. 21, 2008, which application is incorporated by reference herein in its entirety.

### TECHNICAL FIELD

The present invention relates to sash window hardware and, more particularly, to an integrated sash lock and tilt-latch for use in sash windows wherein the assembly is configured for operation of two tilt latch mechanisms with a single sash lock mechanism.

### BACKGROUND OF THE INVENTION

A pivotal sash window adapted for installation in a master frame of a sash window assembly is well-known. The pivotal sash window assembly typically has opposed, vertically extending jambs or guide rails to enable vertical reciprocal sliding movement of the sash window in the master frame while cooperatively engaged with the guide rails. The sash window also has a top sash rail, a base or lower rail and a pair of stiles or side rails cooperatively connected together at adjacent extremities thereof to form a sash frame, usually a rectangular frame.

Hardware is associated with the sash window assembly, such as a sash lock that provides a locking mechanism between an upper sash window and a lower sash window, as well as tilt-latches that releasably engage the guide rails to allow the sash window to pivot from the master frame. Mechanisms have been developed that combine the sash lock mechanism and the tilt-latch mechanism to create an integrated assembly. Other features have also been incorporated into the separate mechanisms. For example, some mechanisms have been developed to operate two tilt-latch mechanisms in connection with a single sash lock mechanism. However, while such combined mechanisms and other features provide a number of advantageous features, they nevertheless have certain limitations. The present invention seeks to overcome certain of these limitations and other drawbacks of the prior art, and to provide new features not heretofore available.

### BRIEF SUMMARY

The following presents a general summary of aspects of the invention in order to provide a basic understanding of the invention. This summary is not an extensive overview of the invention. It is not intended to identify key or critical elements of the invention or to delineate the scope of the invention. The following summary merely presents some concepts of the invention in a general form as a prelude to the more detailed description provided below.

Aspects of the invention relate to an integrated tilt latch and sash lock assembly for a sash window assembly having a lower sash window with a top rail, a bottom rail, and a pair of stiles, and an upper sash window having a keeper. The integrated assembly includes a sash lock mechanism adapted to be supported by the top rail, first and second tilt latch mechanisms adapted to be supported by the lower sash window, first and second connectors, and a drive mechanism. The sash lock mechanism includes a handle and a rotor coupled to the handle and is rotatable by movement of the handle. The first and second tilt latch mechanisms each include a latch bolt slidably supported by the lower sash window and moveable between an extended position and a retracted position. The first connector is operably connected to the rotor and has an end operably connected to the latch bolt of the first tilt-latch mechanism, and the second connector has an end operably connected to the latch bolt of the second tilt-latch mechanism. The drive mechanism operably connects the first connector and the second connector such that movement of the first connector activates the drive mechanism, and activation of the drive mechanism creates reciprocal movement of the second connector. In this configuration, the rotor is moveable among a locked position, an unlocked position and a tiltable position. The rotor is adapted to engage the keeper in the locked position, and the rotor is adapted to be disengaged from the keeper in the unlocked position. When the rotor is moved to the tiltable position, the first connector moves the latch bolt of the first tilt-latch mechanism to the retracted position and the drive mechanism moves the second connector to move the latch bolt of the second tilt-latch mechanism to the retracted position.

According to one aspect, the drive mechanism and the connectors are arranged in a rack and pinion configuration. For example, the drive mechanism may include a rotatable pinion gear engaging the first connector and the second connector, wherein movement of the first connector causes rotation of the pinion gear, and rotation of the pinion gear causes the reciprocal movement of the second connector. In one embodiment, a plurality of teeth are disposed along a portion of each connector, and the pinion gear has a plurality of gear teeth engaging the teeth of the connectors. In another embodiment, the drive mechanism further includes a pinion housing, and the pinion gear is rotatably disposed within the pinion housing.

According to another aspect, the sash lock mechanism includes a sash lock housing adapted to be mounted to the top rail of the lower sash window, and the drive mechanism includes a pinion housing that is mounted to an underside of the sash lock housing.

According to a further aspect, the sash lock mechanism further includes a pawl operably connected to the rotor, such that the rotor and the pawl rotate together over a portion of a range of rotation of the rotor. The pawl includes a base and an appending member extending from the base, and the appending member is operably connected to the first connector. In one embodiment, the pawl is operably connected to the first connector by a connection member connecting the two components. In another embodiment, the pawl is operably connected to the first connector on an opposite side of the pinion gear as the end of the first connector that is operably connected to the latch bolt of the first tilt-latch mechanism.

According to yet another aspect, the drive mechanism includes a pinion gear rotatably disposed within a pinion housing, with the pinion gear engaging the first and second connectors, and a connection member connects the pawl to the first connector. The pinion housing has a stop surface, and the connection member has a confronting surface configured to confront the stop surface when the rotor is in the locked position.

Additional aspects of the invention relate to a sash lock mechanism for a sash window assembly including a lower sash window having a top rail, a bottom rail, and a pair of stiles, and an upper sash window having a keeper. The sash lock mechanism includes a handle, a housing adapted to be supported on a top surface of the top rail, and a rotor coupled to the handle and rotatably mounted on an underside of the housing. The rotor is moveable between at least a locked position and an unlocked position by movement of the handle. The housing has an opening receiving the handle therethrough, and a concealed mounting structure adapted to be connected to a concealed surface of the top rail to mount the sash lock mechanism on the sash rail. The sash lock mechanism may be used independently or in connection with an integrated tilt latch and sash lock assembly.

According to one aspect, the concealed mounting structure includes a flange or pair of flanges depending from an inner surface of the housing and adapted to engage an unexposed rear surface of the top rail. In one embodiment, the flange or flanges each have an aperture configured to receive a screw or other fastener therein to connect the flange to the unexposed rear surface of the top rail.

According to another aspect, the housing has an outer edge configured to sit upon the top surface of the top rail and a rear edge arched above the top surface of the top rail. The concealed mounting structure includes a flange or a pair of flanges depending from an inner surface of the housing, the flange(s) being spaced inwardly from the rear edge and adapted to engage an unexposed rear surface of the top rail. In one embodiment, the flange or flanges each have an aperture configured to receive a screw or other fastener therein to connect the flange to the unexposed rear surface of the top rail.

Further aspects of the invention relate to a sash window including a top rail, a bottom rail, and a pair of stiles connecting the top rail and the bottom rail, the top rail having a top surface and a rear surface and a sash lock opening located in the top surface and the rear surface, such that the rear surface is adapted to be unexposed when the sash window is mounted in a window frame as part of a sash window assembly. The sash window has a sash lock mechanism mounted on the top rail, and the sash lock mechanism includes a handle, a housing supported on the top surface of the top rail, and a rotor coupled to the handle and rotatably mounted on an underside of the housing. The rotor is positioned at least partially within the sash lock opening, the rotor being moveable between at least a locked position and an unlocked position by movement of the handle. The housing has an opening receiving the handle therethrough and a concealed mounting structure connected to the rear surface of the top rail to mount the sash lock mechanism on the sash rail, such that the housing covers at least a portion of the sash lock opening.

According to one aspect, the concealed mounting structure comprises a flange or pair of flanges depending from an inner surface of the housing, such that the flange or flanges engage the rear surface of the top rail adjacent the sash lock opening. In one embodiment, the rear surface of the top rail has a recess or pair of recesses therein adjacent the sash lock opening, such that the flange or flanges each are received in the recess(es) when the housing is mounted on the top rail. The pair of recesses may be positioned on opposite adjacent sides of the sash lock opening.

According to another aspect, the flange has an aperture configured to receive a screw therein to connect the flange to the unexposed rear surface of the top rail.

Still further aspects of the invention relate to an integrated tilt latch and sash lock assembly for a sash window assembly as described above. The integrated assembly includes a sash lock mechanism adapted to be supported by the top rail, a tilt-latch mechanism adapted to be supported by the lower sash window, a connector having an end operably connected to the latch bolt of the tilt-latch mechanism, and a connection member connecting the pawl to the connector. The sash lock mechanism includes a handle, a housing adapted to be supported on a top surface of the top rail and having an opening receiving the handle therethrough, a rotor coupled to the handle and being moveable by movement of the handle, and a pawl operably connected to the rotor, such that the rotor and the pawl rotate together over a portion of a range of rotation of the rotor. The tilt latch mechanism includes a latch bolt slidably supported by the lower sash window and moveable between an extended position and a retracted position. The connection member has a passage receiving a portion of the connector therethrough to connect the connection member to the connector. In this configuration, the rotor is moveable among a locked position, an unlocked position and a tiltable position. The rotor is adapted to engage the keeper in the locked position, and the rotor is adapted to be disengaged from the keeper in the unlocked position. When the rotor is moved to the tiltable position, the connector moves the latch bolt of the tilt latch mechanism to the retracted position.

According to one aspect, the connection member has a plurality of teeth within the passage, and the connector has a plurality of complementary teeth that engage the teeth of the connection member to retain the connection member to the connector.

According to another aspect, the pawl has an appending member, and the connection member has a receiver to receive a portion of the appending member. In one embodiment, the receiver of the connecting member has a flexible tab that flexes to allow the appending member to be inserted into the receiver and retains the appending member within the receiver after insertion. In another embodiment, the connecting member has a ramped surface extending toward the flexible tab to assist insertion of the appending member into the receiver. In a further embodiment, the appending member has a hook thereon, and the hook is received in the receiver of the connecting member.

According to a further aspect, the connecting member has a flexible arm at least partially defining the passage, and the flexible arm flexes to permit insertion of the connector into the passage. In one embodiment, the flexible arm has a locking tab thereon, wherein the locking tab engages the connector to retain the connector within the passage after insertion.

According to yet another aspect, the connecting member has a plurality of flexible arms at least partially defining the passage, and the flexible arms flex to permit insertion of the connector into the passage. In one embodiment, at least two of the flexible arms are positioned in opposed relation to each other, on opposite sides of the passage, to engage the connector in a clamping configuration. In another embodiment, each of the flexible arms has a locking tab thereon, and the locking tabs engage the connector to retain the connector within the passage after insertion.

According to a still further aspect, the connecting member has a plurality of teeth extending into the passage, and the connector has a plurality of teeth disposed along at least a portion of the connector, and wherein the teeth of the connecting member engage the teeth of the connector to retain the connector within the passage.

Other features and advantages of the invention will be apparent from the following description taken in conjunction with the attached drawings.

### BRIEF DESCRIPTION OF THE DRAWINGS

To understand the present invention, it will now be described by way of example, with reference to the accompanying drawings in which:

FIG. 1 is a perspective view of a sash window assembly incorporating an integrated tilt latch and sash lock assembly of the present invention;

FIG. 2 is a perspective view of a portion of a sash window assembly incorporating the integrated tilt latch and sash lock assembly of the present invention;

FIG. 2A is a side view of the sash window assembly and integrated tilt latch and sash lock assembly and top sash member of FIG. 2;

FIG. 3 is a side view of the integrated tilt latch and sash lock assembly of FIG. 2, mounted in a top sash member;

FIG. 3A is a rear view of the integrated tilt latch and sash lock assembly and top sash member of FIG. 3;

FIG. 4 is a rear perspective view of one embodiment of an integrated tilt latch and sash lock assembly of the present invention, shown in an unlocked position;

FIG. 4A is a top view of the integrated tilt latch and sash lock assembly of FIG. 4, shown in the unlocked position;

FIG. 5 is a bottom view of the integrated tilt latch and sash lock assembly of FIG. 4, shown in the unlocked position;

FIG. 6 is a front view of the integrated tilt latch and sash lock assembly of FIG. 4, shown in the unlocked position;

FIG. 7 is a rear perspective view of the integrated tilt latch and sash lock assembly of FIG. 4, shown in a locked position;

FIG. 8 is a bottom view of the integrated tilt latch and sash lock assembly of FIG. 4, shown in the locked position;

FIG. 9 is a top view of the integrated tilt latch and sash lock assembly of FIG. 4, shown in the locked position;

FIG. 10 is a front view of the integrated tilt latch and sash lock assembly of FIG. 4, shown in the locked position;

FIG. 11 is a perspective view of the integrated tilt latch and sash lock assembly of FIG. 4, shown in a tiltable position;

FIG. 12 is a bottom view of the integrated tilt latch and sash lock assembly of FIG. 4, shown in the tiltable position;

FIG. 13 is a top view of the integrated tilt latch and sash lock assembly of FIG. 4, shown in the tiltable position;

FIG. 14 is a front view of the integrated tilt latch and sash lock assembly of FIG. 4, shown in the tiltable position;

FIG. 15 is a bottom perspective view of a sash lock mechanism and a keeper of the integrated tilt latch and sash lock assembly of FIG. 4, shown in the unlocked position;

FIG. 15A is a cross-sectional view of the sash lock mechanism and keeper of FIG. 15, shown in the locked position;

FIG. 15B is a rear view of the sash lock mechanism and keeper of FIG. 15, shown in the locked position;

FIG. 16 is a rear perspective view of the sash lock mechanism of FIG. 15, shown in the unlocked position;

FIG. 17 is a bottom view of the sash lock mechanism of FIG. 15, shown in the unlocked position;

FIG. 18 is a rear view of the sash lock mechanism and keeper of FIG. 15, shown in the unlocked position;

FIG. 19 is a top view of a pawl and a cap of the sash lock mechanism of FIG. 15 and an end of a connector of the integrated tilt latch and sash lock assembly of FIG. 4;

FIG. 20 is a perspective view of the pawl, cap, and connector end of FIG. 19;

FIG. 21 is a top view of the connector of the integrated tilt latch and sash lock assembly of FIG. 4;

FIG. 22 is a rear perspective view of the connector of FIG. 21;

FIG. 23 is a front view of the connector of FIG. 21;

FIG. 24 is a bottom perspective view of the pawl of FIG. 19;

FIG. 25 is a perspective view of the pawl of FIG. 19;

FIG. 26 is a perspective view of a cam of the sash lock mechanism of FIG. 15;

FIG. 27 is a bottom view of the cam of FIG. 26;

FIG. 28 is a bottom perspective view of an actuator handle of the sash lock mechanism of FIG. 15;

FIG. 29 is a perspective view of a housing of the sash lock mechanism of FIG. 15;

FIG. 29A is a bottom view of the housing of FIG. 29;

FIG. 30 is a perspective view of a tilt latch mechanism of the integrated tilt latch and sash lock assembly of FIG. 4;

FIG. 31 is a bottom perspective view of the tilt latch mechanism of FIG. 30;

FIG. 32 is a rear view of the tilt latch mechanism of FIG. 30;

FIG. 33 is a bottom view of the tilt latch mechanism of FIG. 30 mounted in a stile of a sash window assembly;

FIG. 34 is a perspective view of the tilt latch mechanism and stile of FIG. 33;

FIG. 35 is a perspective view of a latch bolt of the tilt latch mechanism of FIG. 30;

FIG. 36 is a side view of the tilt latch mechanism of FIG. 30;

FIG. 37 is a front view of the latch bolt of FIG. 35;

FIG. 38 is a bottom perspective view of the latch bolt of FIG. 35 and an end of the connector of the integrated tilt latch and sash lock assembly of FIG. 4;

FIG. 39 is a perspective view of the portion of the sash window assembly of FIG. 2;

FIG. 40 is a perspective view of a portion of a sash window with one embodiment of an integrated tilt latch and sash lock assembly having two tilt latch mechanisms and a single sash lock mechanism;

FIG. 41 is a rear perspective view of the portion of the sash window shown in FIG. 40;

FIG. 42 is a rear perspective view of the integrated tilt latch and sash lock assembly of FIG. 40, shown mounted in a top sash rail;

FIG. 43 is a front view of the integrated tilt latch and sash lock assembly of FIG. 40;

FIG. 44 is a bottom view of the integrated tilt latch and sash lock assembly of FIG. 40;

FIG. 45 is a perspective view of the integrated tilt latch and sash lock assembly of FIG. 40;

FIG. 46 is an end view of two connectors and a drive mechanism of the integrated tilt latch and sash lock assembly of FIG. 40;

FIG. 47 is a perspective view of the drive mechanism of the integrated tilt latch and sash lock assembly of FIG. 40;

FIG. 48 is a perspective view of a pinion gear of the drive mechanism of FIG. 47;

FIG. 49 is a perspective view of a connector of the integrated tilt latch and sash lock assembly of FIG. 40;

FIG. 50 is a perspective view of a portion of a connector and a latch bolt of the integrated tilt latch and sash lock assembly of FIG. 40;

FIG. 51 is a bottom perspective view of a drive mechanism, a portion of a sash lock mechanism, and portions of two connectors of the integrated tilt latch and sash lock assembly of FIG. 40;

FIG. 52 is a perspective view of a pawl and a connection member of the integrated tilt latch and sash lock assembly of FIG. 40;

FIG. 53 is a top view of the pawl and connection member of FIG. 52;

FIG. 54 is a perspective view of the connection member of the integrated tilt latch and sash lock assembly of FIG. 40;

FIG. 55 is a front view of the connection member of FIG. 54;

FIG. 56 is an end view of the connection member of FIG. 54;

FIG. 57 is a bottom perspective view of one embodiment of a sash lock mechanism having a forced entry resistance mechanism, shown in a locked position;

FIG. 58 is a focused bottom perspective view of the sash lock mechanism of FIG. 57;

FIG. 59 is a cross-sectional view of the sash lock mechanism of FIG. 57;

FIG. 60 is a bottom perspective view of the sash lock mechanism of FIG. 57, shown in between the locked position and an unlocked position, with the locking mechanism in a free position;

FIG. 61 is a cross-sectional view of the sash lock mechanism as shown in FIG. 60;

FIG. 62 is a perspective view of the sash lock mechanism of FIG. 57;

FIG. 63 is a perspective view of a portion of a sash window with another embodiment of an integrated tilt latch and sash lock assembly having two tilt latch mechanisms and a single sash lock mechanism;

FIG. 63A is a rear perspective view of a portion of the sash window of FIG. 63;

FIG. 63B is a rear perspective view of the integrated tilt latch and sash lock assembly of FIG. 63, shown mounted in a top sash rail;

FIG. 64 is a bottom view of the sash lock mechanism of the integrated tilt latch and sash lock assembly of FIG. 63;

FIG. 65 is a front view of the integrated tilt latch and sash lock assembly of FIG. 63;

FIG. 66 is a bottom perspective view of the integrated tilt latch and sash lock assembly of FIG. 63;

FIG. 67 is a perspective view of the integrated tilt latch and sash lock assembly of FIG. 63;

FIG. 68 is an end view of two connectors, a connection member, and a drive mechanism of the integrated tilt latch and sash lock assembly of FIG. 63;

FIG. 69 is a perspective view of the drive mechanism of the integrated tilt latch and sash lock assembly of FIG. 63;

FIG. 70 is a perspective view of a pinion gear of the drive mechanism of FIG. 69;

FIG. 71 is a perspective view of a connector of the integrated tilt latch and sash lock assembly of FIG. 63;

FIG. 72 is a perspective view of a portion of a connector and a latch bolt of the integrated tilt latch and sash lock assembly of FIG. 63;

FIG. 73 is a perspective view of a drive mechanism, a portion of a sash lock mechanism, a connection member, and portions of two connectors of the integrated tilt latch and sash lock assembly of FIG. 63;

FIG. 74 is a perspective view of a pawl and a connection member of the integrated tilt latch and sash lock assembly of FIG. 63;

FIG. 75 is a top view of the pawl and connection member of FIG. 74;

FIG. 76 is a right perspective view of the connection member of FIG. 68;

FIG. 77 is a left perspective view of the connection member of FIG. 68;

FIG. 78 is a bottom view of the drive mechanism, the connection member, and the two connectors of FIG. 68;

FIG. 79 is a left perspective view of another embodiment of a connection member suitable for use with the integrated tilt latch and sash lock assembly of FIG. 63; and

FIG. 80 is a right perspective view of the connection member of FIG. 79.

### DETAILED DESCRIPTION

While this invention is susceptible of embodiment in many different forms, there are shown in the drawings, and will herein be described in detail, preferred embodiments of the invention with the understanding that the present disclosure is to be considered as an exemplification of the principles of the invention and is not intended to limit the broad aspect of the invention to the embodiments illustrated.

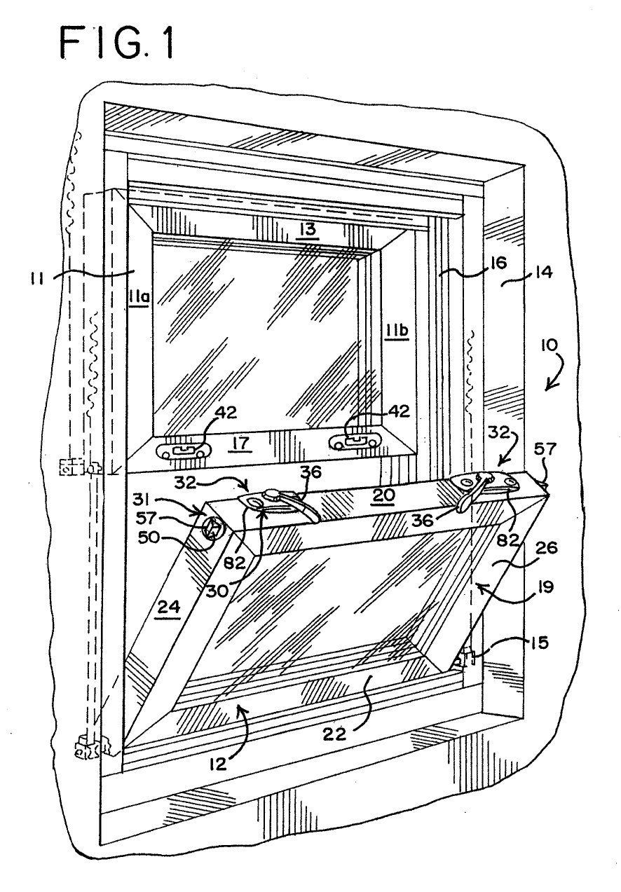

A sash window assembly 10 is shown in FIG. 1. The sash window assembly 10 is a double-hung window assembly having a pivotal bottom sash window 12 installed in a master frame 14. The bottom sash window 12 is pivotally mounted to the master frame 14 by a pivot-corner/balance shoe assembly 15. The master frame 14 has opposed, vertically extending guide rails 16 or jambs 16. The bottom sash window 12 has a top sash rail 20, a base 22 or bottom sash rail 22 and a pair of stiles 24,26 or side rails 24,26, cooperatively connected together at adjacent extremities thereof to form a sash frame 19, which is typically rectangular, although other shapes are possible. The sash frame 19 with which the integrated assembly 30 described herein is employed is typically made from vinyl extrusions known in the art. While the present invention can be used with any type of frame 19, in one exemplary embodiment, the invention is used with a window assembly 10 having a frame 19 made of vinyl. In other embodiments, it is contemplated that the frame 19 could be made from wood, masonite or press board, or from extrusions or pulltrusions that are filled with fiberglass, epoxy, plastic, or wood chips, or from other materials, including aluminum. In the embodiment shown in FIG. 1, the window assembly 10 also has a top sash window 11, which is similar in structure to the bottom sash window 12, having a top rail 13, a bottom rail 17, and two stiles 11a,11b.

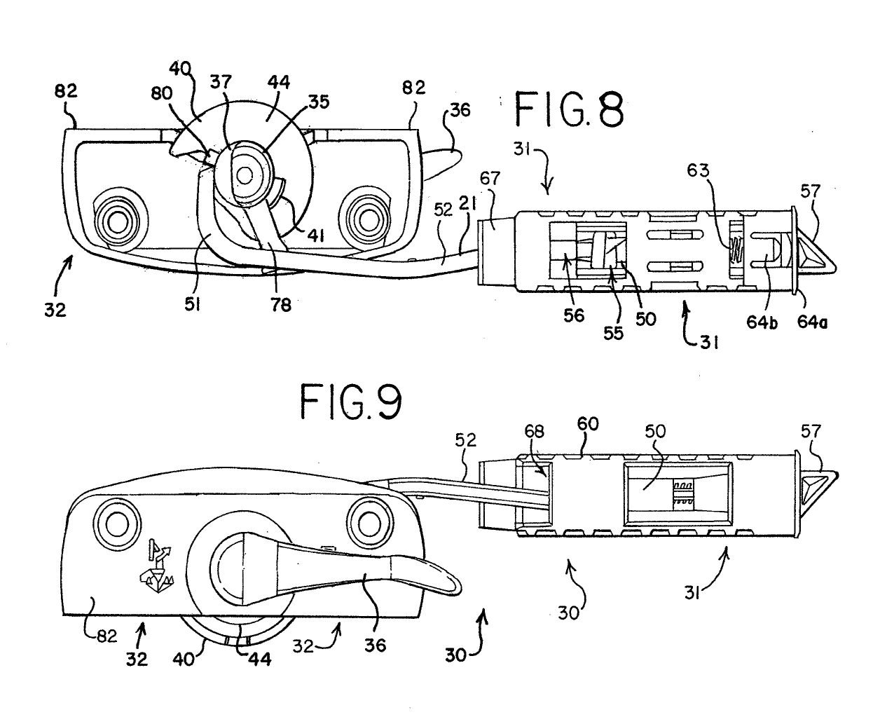

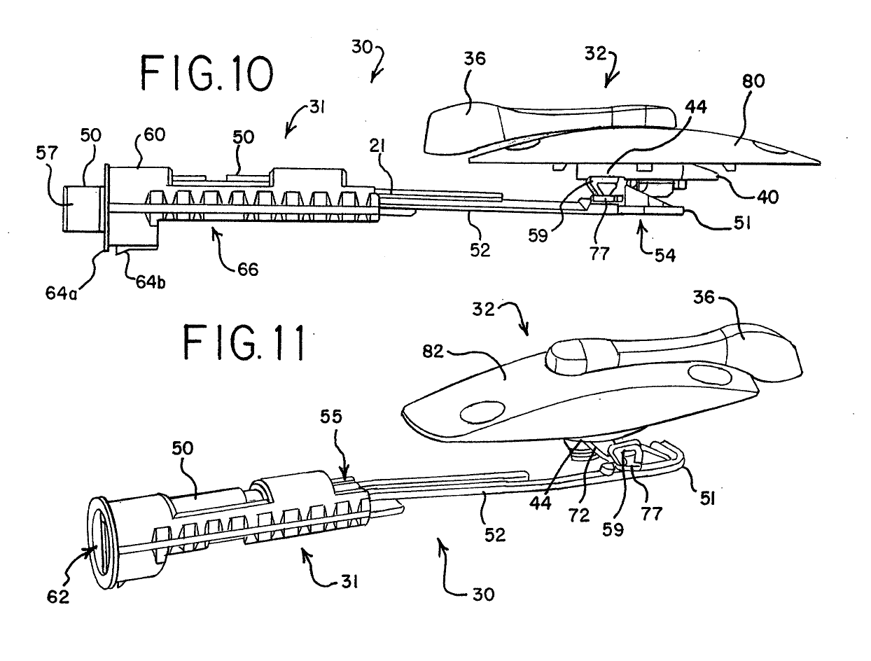

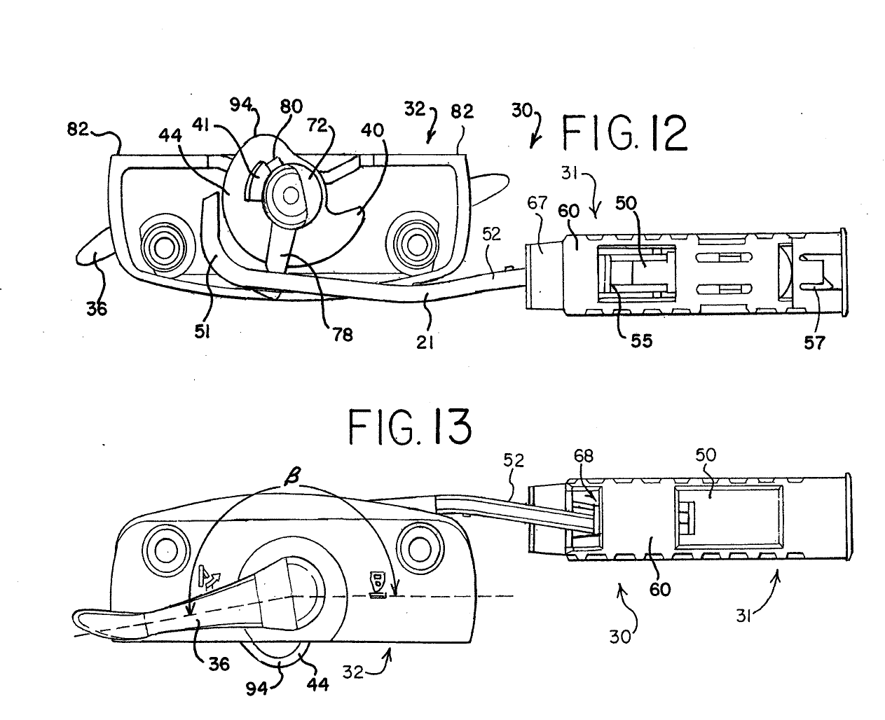

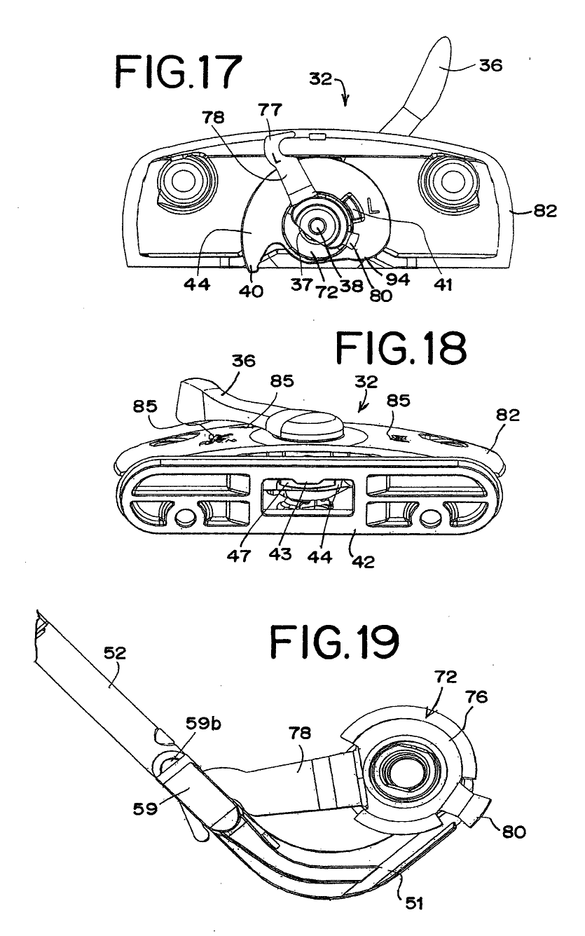

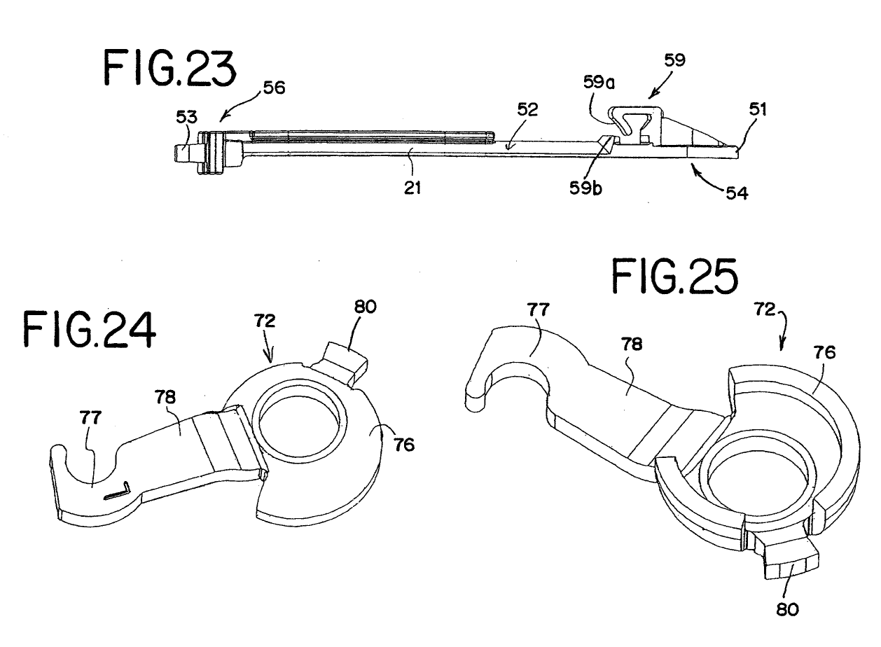

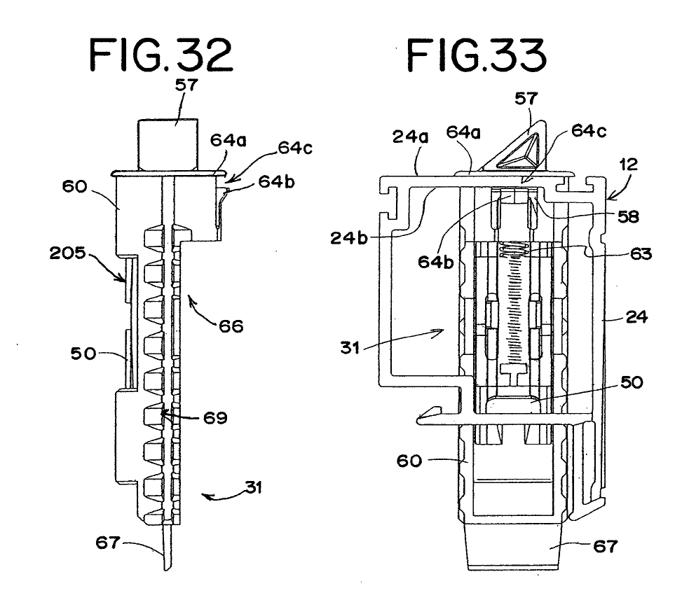

In accordance with one embodiment of the invention, the sash window 12 includes an integrated tilt latch and sash lock assembly 30, which is illustrated in FIGS. 1-38. The integrated assembly 30 provides a sash locking operation. Additionally, the integrated assembly 30 provides a tilt-latch operation. While the integrated assembly 30 will be described herein with respect to a single integrated assembly 30, the integrated assembly 30 can also be used in connection with a dual integrated assembly. In such an instance, the second half of the integrated assembly will be substantially the same as that half of the integrated assembly 30 described herein. Also, as can be understood from FIG. 1, one embodiment of the invention has a left-side integrated assembly 30 and a right-side integrated assembly 30. It is understood that the description herein is applicable to both a left-side integrated assembly 30 and a right-side integrated assembly 30. It is further understood that the features of the integrated assembly 30 may be incorporated into a single integrated assembly having a single sash lock mechanism and two tilt latch mechanisms.

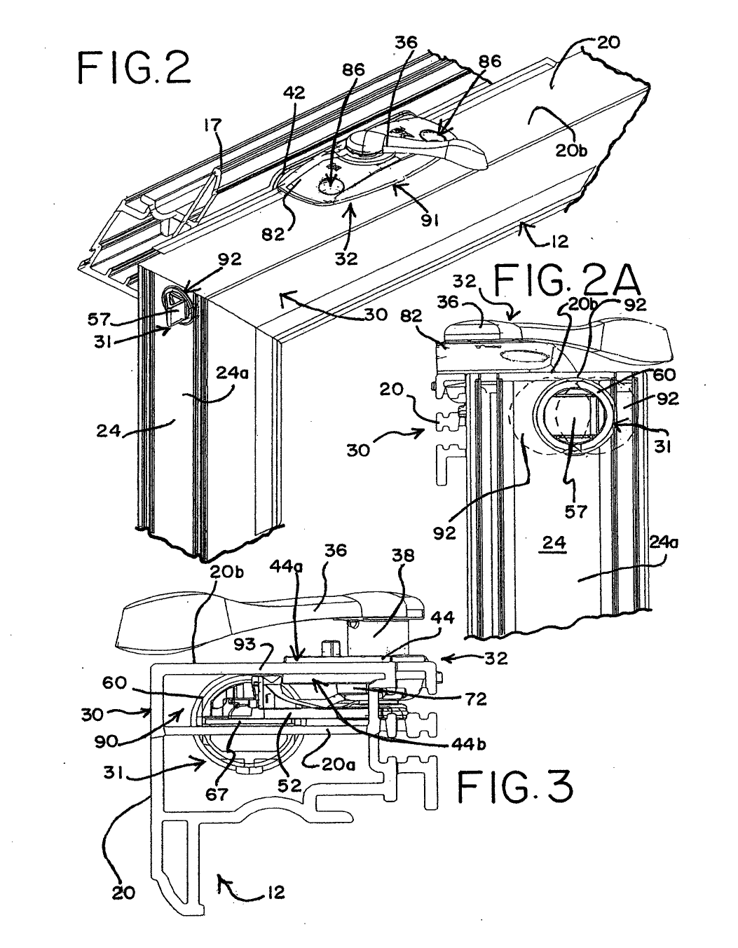

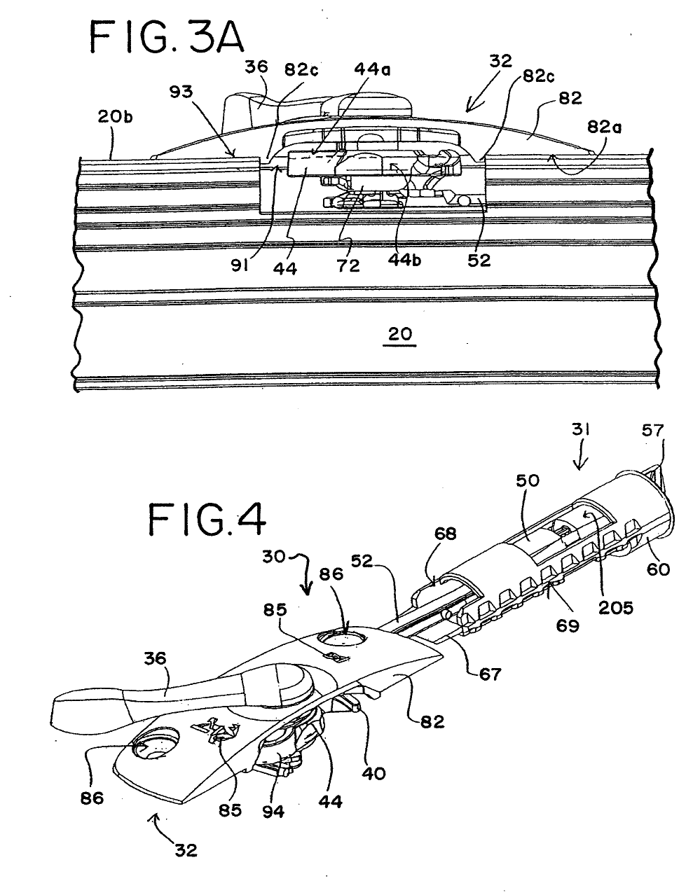

Referring to FIGS. 1-3, the integrated tilt latch and sash lock assembly 30 generally includes a sash lock mechanism 32 and a tilt latch mechanism 31 that are interconnected by a connector 52, and a keeper or locking bracket 42. The left-side integrated assembly 30 shown in FIGS. 2-3 is supported by, and mounted partially within, the top sash rail 20 and the left stile 24. Generally, the sash lock mechanism 32 and the keeper 42 provide the sash locking operation, the tilt latch mechanism 31 provides the tilt-latch operation, and the connector 52 connects the sash lock mechanism 32 and the tilt latch mechanism 31. The integrated assembly 30 is moveable between a locked position, an unlocked position, and a tiltable position. In the locked position, the tilt latch mechanism 31 prevents the sash window 12 from tilting and the sash lock mechanism 32 prevents the sash window 12 from sliding within the master frame 14. In the unlocked position, the tilt latch mechanism 31 still prevents the sash window 12 from tilting, but the sash lock mechanism 32 is released, leaving the sash window 12 free to slide within the master frame 14. In the tiltable position, the tilt latch mechanism 31 is released, and the sash window 12 may be tilted as shown in FIG. 1. The operation of the integrated assembly 30 is described in greater detail below.

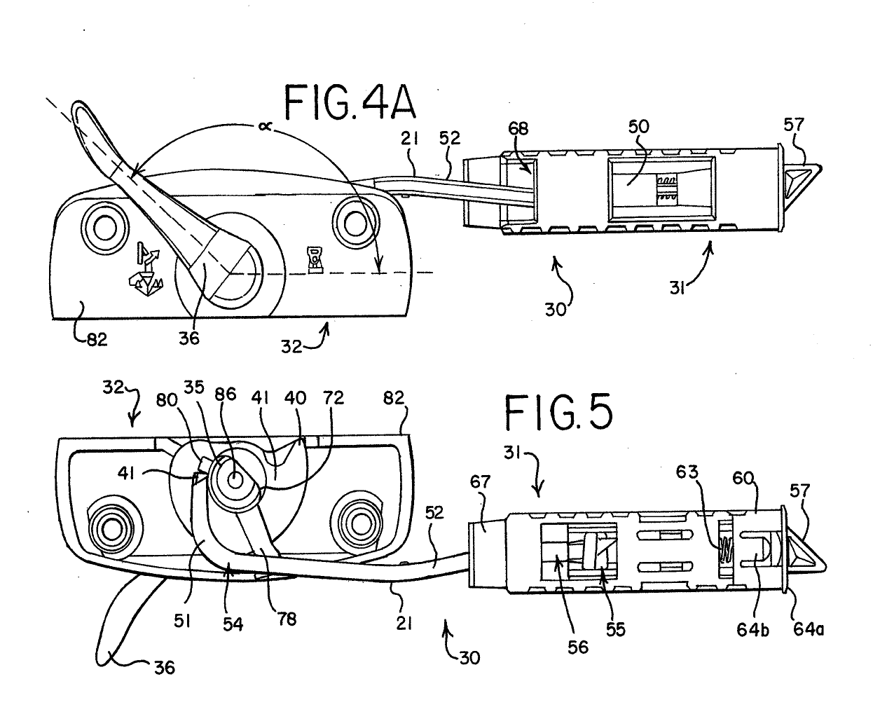

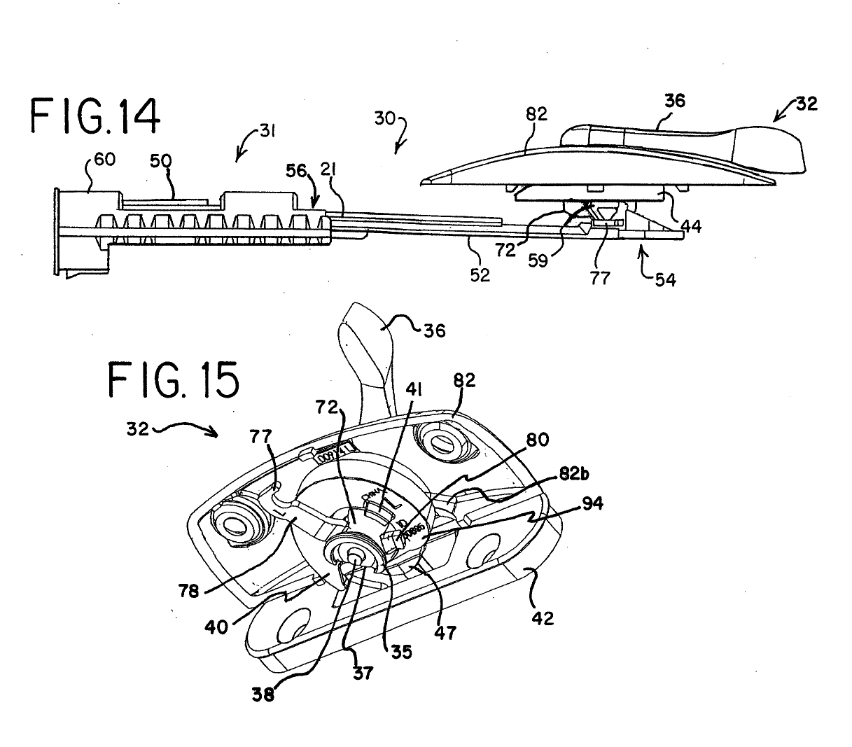

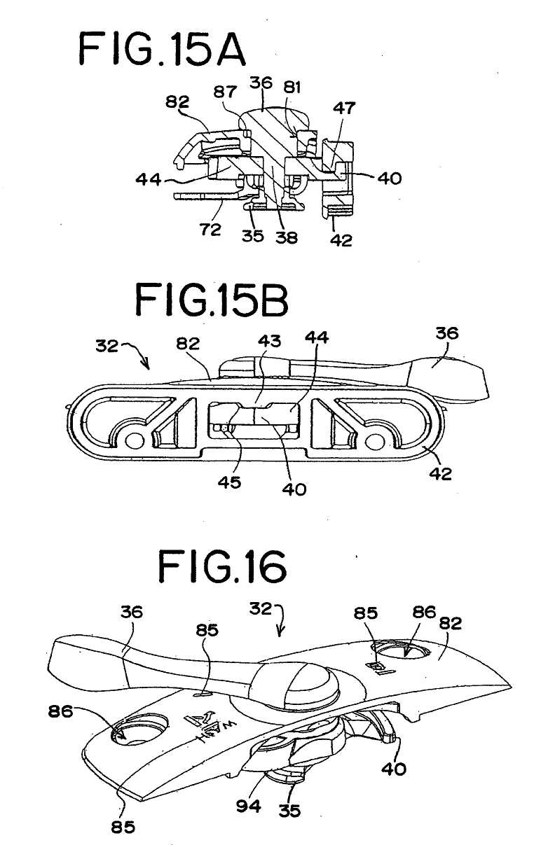

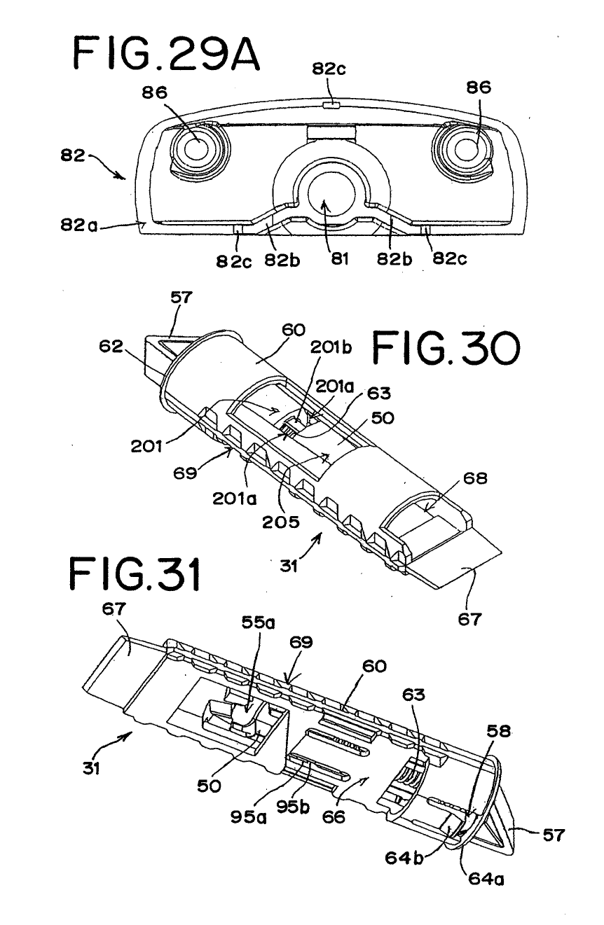

As shown in FIGS. 4-20, the illustrated embodiment of the sash lock mechanism 32 includes an actuator arm or handle 36 connected to a cam or rotor 44 which is operably connected to a pawl 72, and a housing 82 supporting the other components of the sash lock mechanism 32. The housing 82 is adapted to be mounted on the top sash rail 20 to mount the sash lock mechanism 32 to the sash window assembly 10, and is shown in greater detail in FIG. 29. In one exemplary embodiment, the housing 82 is made of cast metal and has a curvilinear surface. The housing 82 has an opening 81 therein and indicia 85 on the top surface thereof, as well as a pair of screw apertures 86 for insertion of fasteners to connect the housing 82 to the top sash rail 20. Additionally, as shown in FIG. 29, the housing 82 has an annular ledge 87 having two protrusions 88 positioned at points around the ledge 87. The inside of the housing 82 also has an added beam rail 82b, to provide more structural support to the housing 82, as shown in FIGS. 15 and 29A. Further, as illustrated in FIGS. 3A and 29A, the housing 82 has several tabs 82c that abut the inner surfaces of the sash lock opening 91 in the top sash rail 20 to hold the housing 82 in place when mounted on the top sash rail 20.

The actuator handle 36 has a shaft 38 extending through the opening 81 in the housing 82 and connected to the cam 44. As shown, for example, in FIG. 15A, the shaft 38 is received within a complementarily-shaped shaft opening 39 in the cam 44, so that movement of the actuator handle 36 effects rotation of the cam 44. Additionally, a projection 89 is located at the base of the shaft 38, as shown in FIG. 28. When the shaft 38 is inserted into the opening 81 in the housing 82, the projection 89 engages the protrusions 88 on the ledge 87 of the housing 82 during rotation of the actuator handle 36, creating a tactile “feel” and indicating positions of the actuator handle 36, as described in greater detail below. The actuator handle 36 is adapted to be manipulated by a user to move the integrated assembly 30 between the locked position, the unlocked position, and the tiltable position, and thus, the actuator handle 36 has a locked position, an unlocked position, and a tiltable position. The indicia 85 on the housing indicate when the actuator handle 36 is in each of the three positions.

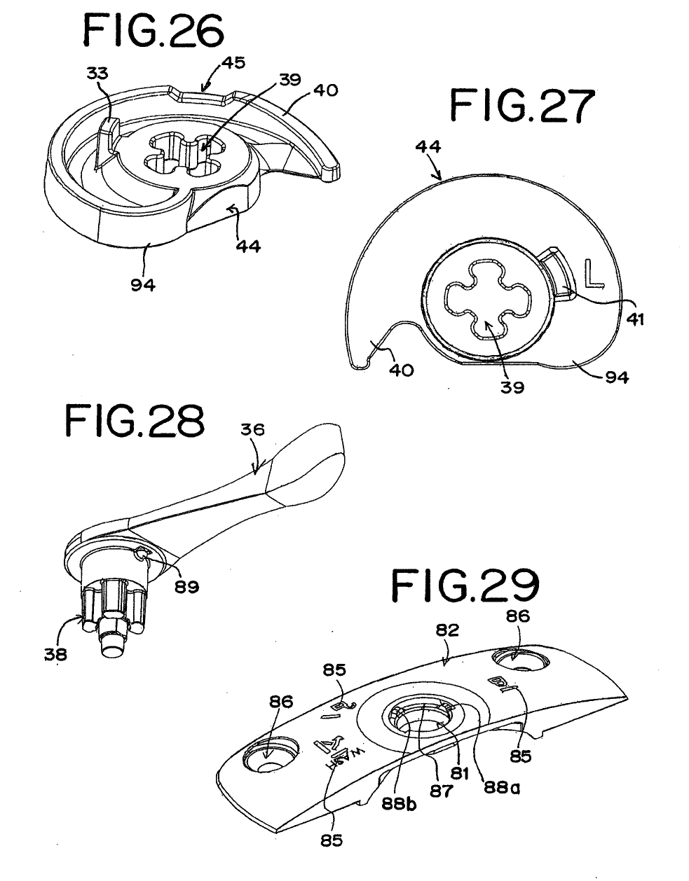

An exemplary embodiment of the cam 44 is illustrated in greater detail in FIGS. 26-27. The cam 44 is rotatably supported within and below the housing 82 and includes a locking member 40 configured to engage the keeper 42 to lock the sash window 12. The cam 44 is rotated by movement of the actuator handle 36 between a locked position, wherein the locking member 40 of the cam 44 engages the keeper 42 to lock the window 12 in place, and an unlocked position, wherein the locking member 40 of the cam 44 is disengaged from the keeper 42, allowing the window 12 to slide. The cam 44 also includes an abutment member 41 depending from the bottom surface thereof and a stub 33 extending from the top surface thereof. The stub 33 abuts the housing 82 at the ends of the range of rotation of the cam 44, thereby defining and limiting the range of rotation. The abutment member 41 engages the pawl 72, as described in greater detail below. Further, the cam 44 has a means 94 for selectively preventing movement of the integrated assembly 30 to the tiltable position, which generally takes the form of an extending member 94 extending from the cam 44. The extending member 94 may also be referred to as a leg 94 or an abutment member 94 for abutting the keeper 42. In one embodiment, illustrated in FIGS. 26-27, the extending member 94 is an enlarged or eccentric portion 94 of the cam 44 that is rotationally opposite of the locking member 40. When the integrated assembly 30 is in the unlocked position, and a user wishes to move the actuator handle 36 to the tiltable position, the eccentric portion 94 abuts a portion of the keeper 42, preventing rotation of the cam 44. In order to rotate the actuator handle 36 and cam 44 further, the user must lift the sash window 12 slightly, to allow the eccentric portion 94 to clear the keeper 42, and the actuator handle 36 can thus be moved to the tiltable position. Still further, in one embodiment, the cam 44 and the keeper 42 have complementary engaging structures that engage each other when the cam 44 is in the locked position to provide a more secure locking connection and create a tactile feel to alert the user that the cam 44 is in the locked position. As shown in FIGS. 15, 15B, and 18, the cam 44 has a notch 45 on or near the locking member 40 that receives a projection 43 on the keeper 42 when the cam 44 is in the locked position to accomplish this function.

The interlocking between the locking member 40 of the cam or rotor 44 and the keeper 42 is illustrated in more detail in FIGS. 15A and 15B. As shown in FIGS. 15, 15B, and 18, the keeper 42 has a projection 43 that is cooperatively dimensioned with a notch 45 in the rotor 44. When the notch 45 and the projection 43 are aligned, the projection 43 will slip into the notch 45, giving the user a “feel” indication that the assembly 30 is securely in the locked position. Additionally, the keeper 42 has a tongue 47 that interlocks with the locking member 40 of the rotor 44 to hold the sash window 12 more securely closed and give additional protection against forced entry, as illustrated in FIGS. 15, 15A, and 15B.

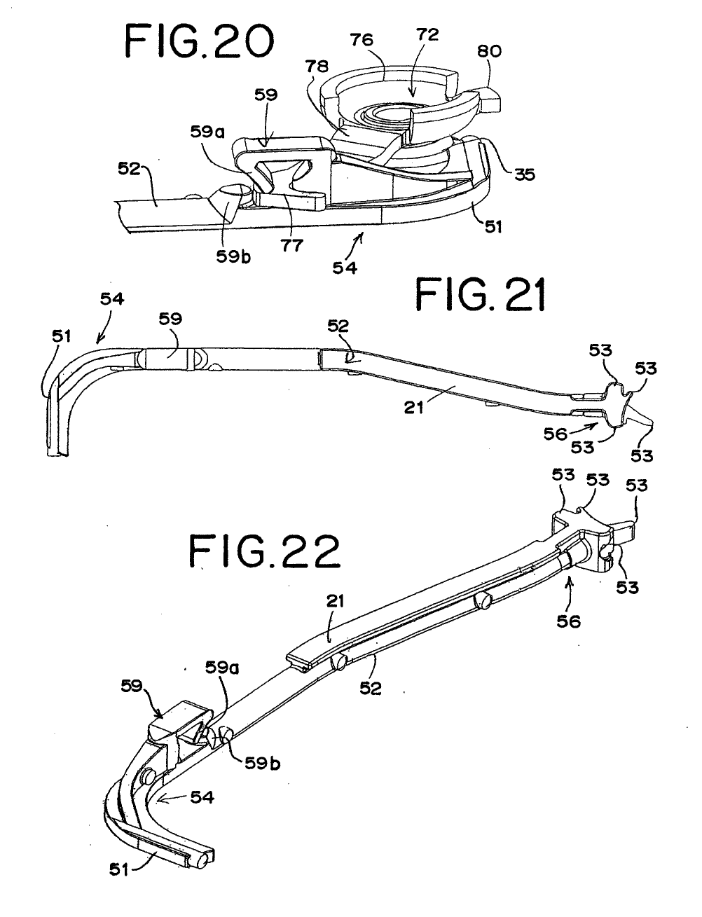

One exemplary embodiment of the pawl 72 is illustrated in greater detail in FIGS. 19-20 and 24-25. The pawl 72 includes a base 76 and a pawl member or appending member 78. The pawl 72 is operably associated with the connector 52 that extends away from the sash lock mechanism 32 to the tilt-latch mechanism 31. In one embodiment, the appending member 78 contains a hook 77 that engages a hitch 59 on the connector 52, directly connecting the pawl 72 to the connector 52, as illustrated in FIGS. 19-20. In this embodiment, the connector 52 contains a retaining structure to hold the hook 77 in place, which includes a flexible lip 59a and a protrusion 59b. The combination of the lip 59a and the protrusion 59b force the hook 77 into the retaining structure and then hold the hook 77 in place once the hook 77 is engaged with the hitch 59, forming a snap-fit connection. The pawl 72 is also operably connected to the cam 44 such that rotation of the cam 44 causes rotation of the pawl 72 through a portion of the range of rotation of the cam 44. The cam 44 and the pawl 72 are disposed proximate one another in operable association with each other and a tab 80 extends outwardly from an outer surface of the pawl base 76 to engage the abutment member 41 of the cam 44. Movement of the actuator handle 36 causes the cam 44 to rotate. In the embodiment illustrated, the cam 44 rotates freely and independently of the pawl 72 for a portion of the range of rotation. However, at a point in the rotation, the abutment member 41 of the cam 44 abuttingly engages the tab 80 of the pawl 72, such that when engaged, the cam 44 and the pawl 72 generally rotate in unison. Thus, the actuator handle 36, the cam 44, and the pawl 72 are all operably associated with each other.

The sash lock mechanism 32 illustrated in FIGS. 4-20 additionally includes an asymmetrical or eccentric cap 35 that is operably coupled to the actuator 36 to rotate with movement of the actuator 36. In one embodiment, the cap 35 is positioned on the bottom side of the pawl 72, opposite the rotor 44, protecting the pawl 72 and securing it to the sash lock mechanism 32. Additionally, in one embodiment, the cap 35 is asymmetrical and eccentric in shape, having a beveled or flattened portion 37. The cap 35 operates in a camming action with a curved arm 51 of the connector 52. As the actuator 36 is turned from the locked position, the cap 35 rotates with the cam 44. At a certain point along the rotation, the eccentric nature of the cap 35 causes the cap 35 to engage the arm 51 on the connector 52. Further rotation of the cap 35 exerts a force on the connector arm 51, pulling the connector 52 slightly, which in turn retracts the latch bolt 50 slightly. This permits the integrated assembly 30 to begin retraction of the latch bolt 50 prior to the point where the rotor 44 abuttingly engages the pawl 72.

The integrated assembly shown in FIGS. 4-14 contains one embodiment of the tilt latch mechanism 31, which is shown in greater detail in FIGS. 30-38. The tilt latch mechanism 31 is disposed within the sash window 12, such as within a cavity 90 in the sash window 12 that extends through both the stile 24,26 and the top sash rail 20. This embodiment of the tilt latch mechanism 31 includes a latch bolt 50 disposed within a housing 60 and coupled to the connector 52, and a means 63 for biasing the latch bolt outwardly, which, in the embodiment illustrated in FIGS. 30-33, is a spring 63. It is understood the spring 63 is generally positioned between the latch bolt 50 and the housing 60 to bias the latch bolt 50 outwardly from the housing 60 through a latch bolt opening 62 in the end of the housing 60. In one embodiment, the spring 63 is not evenly coiled, but rather has densely-coiled portions and more loosely-coiled portions. These densely-coiled portions prevent springs 63 stored in bulk from becoming intertwined and/or stuck together.

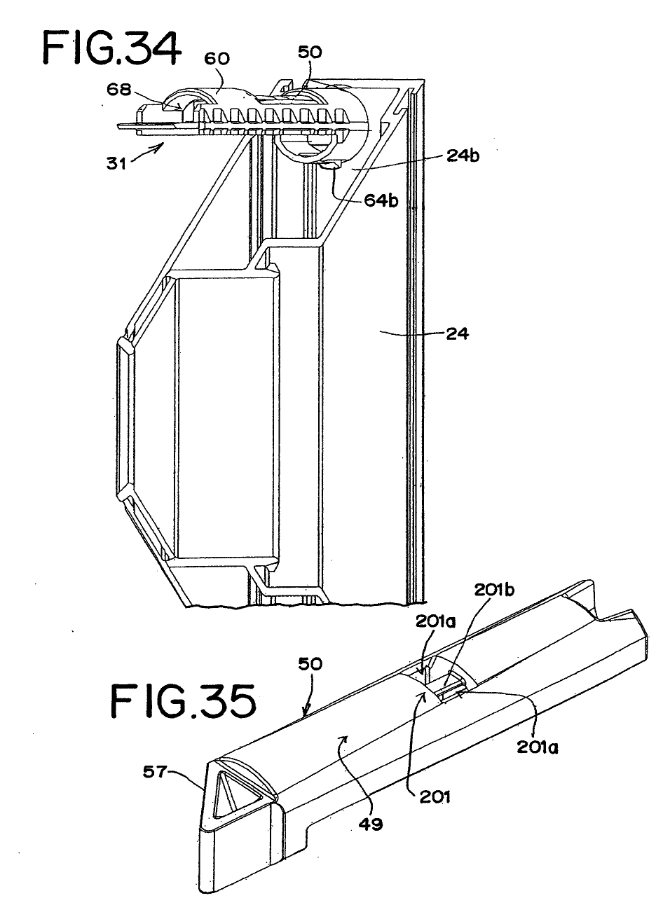

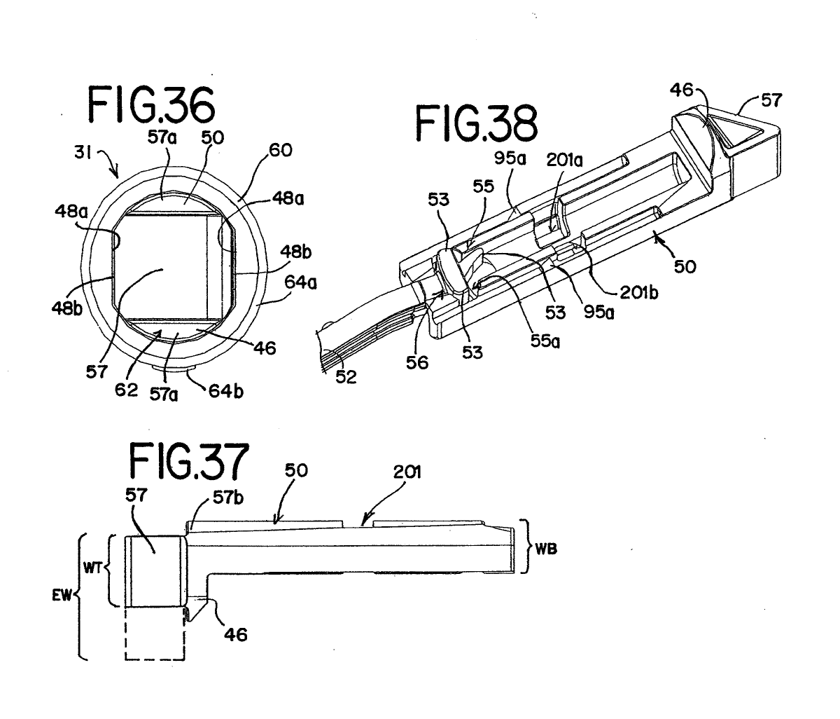

The housing 60 is used to support the latch bolt 50 within the sash window 12. In one embodiment, the housing 60 is substantially cylindrical, having a curvilinear outer surface and appearing round when viewed in a side view (FIG. 36). The cylindrical housing 60 is adapted to be inserted into a round hole 92 in one of the stiles 24,26, as shown in FIGS. 2, 2A, 33, and 34, so that no hole in the top sash rail 20 is necessary for installation, and the tilt latch mechanism 31 is completely hidden beneath the top sash rail 20. The housing 60 has opposed stile-engaging members 64 that are adapted to engage both an outer surface 24a and an inner surface 24b of the stile 24. In the embodiment shown in FIGS. 33-34, the tilt latch mechanism 31 has stile-engaging members 64 in the forms of a circular flange 64a around the latch bolt opening 62 that engages the outer surface 24a of the stile 24 and a flexible, resilient tab 64b that engages the inner surface 24b of the stile 24. More generally, the tilt latch housing 60 contains a flange 64a and a tab 64b defining a gap 64c therebetween, and a portion of the lower sash window 12 is received within the gap 64c. The flange 64a and the tab 64b cooperate to hold the tilt latch mechanism 31 in place within the sash window 12. The housing 60 also includes a window 58 around the tab 64b, which provides ample room for the tab 64b to flex upward upon contact with the stile 24 during insertion of the tilt latch mechanism 31 into the sash window 12. In the embodiment shown in FIGS. 33-34, the window 58 is dimensioned cooperatively with the tab 64b, so that the tab 64b can easily deflect into the housing 60 through the window 58. Once the tab 64b clears the inner surface 24b of the stile 24, the resilient tab 64b snaps back into its original position to engage the inner surface 24b of the stile 24. The flexible, resilient tab 64b is able to deflect as described above without being permanently deformed.

The cylindrical housing 60 has a curvilinear outer sidewall 61 having a series of ribs 69 thereon, a rear opening 68, and a stabilizing member 67 proximate the rear opening 68. The rear opening 68 allows the connector 52 to pass through and connect to the latch bolt 50, and is defined at the rear of the housing 68, opposite the latch bolt opening 62, as illustrated in FIGS. 4-14 and 30. The ribs 69 create a waffle-structure that strengthens the housing and improves its strength:weight ratio. In one embodiment, the stabilizing member 67 is a flat tongue 67 extending from the housing 60 proximate the rear opening 68, and is adapted to engage an inner wall 20a of the top sash rail 20 to stabilize the housing 60 and prevent the housing 60 from rotating within the sash window 12. As shown in FIG. 3, the stabilizing member 67 rests upon the inner wall 20a of the top sash rail 20. It is understood that the stabilizing member 67 may have another configuration suitably adapted to engage the inner wall of the top rail 20. The housing 60 of the tilt latch mechanism shown in FIGS. 4-14 and 30-38 also has a cut-out portion 66 at the bottom of the housing 60 and a slot or elongated opening 23 at the top of the housing 60. The cut-out portion 66 decreases the size of the housing 60, both allowing the housing 60 to fit into smaller spaces and decreasing the amount of material used to manufacture the housing 60. Thus, a portion of the housing proximate the latch bolt opening 62 is a complete cylinder, and the rear portion of the housing 60 is partially-cylindrical. The slot 23 allows for insertion of an actuator (not shown) to operate the tilt latch mechanism 31 independently, and the latch bolt has connecting structure 23a, 23b to permit connection of such an actuator (FIG. 35).

The latch bolt 50 of the tilt latch mechanism 31 of FIGS. 4-14 and 30-38 is shown alone in FIGS. 35, 37, and 38. The latch bolt 50 is adapted to slide within the housing 60 between a retracted position, wherein the nose or tip 57 of the latch bolt 50 is retracted into the housing 60, and an outwardly-extended position, wherein the nose 57 of the latch bolt 50 extends beyond the end of the housing 60 and beyond the edge of the stile 24,26. This movement of the latch bolt 50 is shown in FIGS. 4-14 and is discussed in greater detail below. When the sash window 12 is closed, the latch bolt 50 engages one of the guide rails 16 in the outwardly-extended position to prevent the window 12 from tilting. The spring 63 is generally positioned between a portion of the latch bolt 50 and a portion of the housing 60, and biases the latch bolt 50 towards the outwardly-extended position. Additionally, the nose or tip 57 of the latch bolt 50 is generally angled or beveled on one side, so that the window 12 may be shut wherein the beveled surfaces engage edges of the guide rails 16 as the sash window 12 is pivoted to the vertical position wherein the latch bolts 50 are retracted into the housing 60 and then extend back outwardly to engage the guide rails 16 when the sash window is in the unpivoted position.

The latch bolt 50 is dimensioned to fit properly within the cylindrical housing 60, which has a rounded latch bolt opening 62, as shown in FIG. 36. Thus, in the embodiment the latch bolt 50 has at least one generally rounded portion. In the embodiment shown in FIGS. 35-38, the latch bolt opening 62 of the housing 60 is generally circular with beveled or flat edges 48a, and an end portion 46 of the latch bolt 50 is similarly dimensioned, being generally circular with beveled flat edges 48b. The cooperative engagement of the beveled edges 48a,48b prevent rotation of the latch bolt 50 within the housing 60. In one embodiment, the tip 57 of the latch bolt 50 has a different cross-sectional shape than the portion of the latch bolt 50 immediately adjacent the tip 57. As shown in FIG. 36, the tip 57 is rectangular and extends from the enlarged end portion 46 that is dimensioned to fill the latch bolt opening 62. The transition or “filler” segments 57a caused by difference in shape between the rectangular tip 57 and the rounded body of the latch bolt 50 can be seen in FIG. 36. As discussed, the tilt-latch housing 60 has generally circular cross-section while the tip 57, or nose 57, of the latch bolt 50 has more of a rectangular cross-section. The latch bolt 50 includes the filler segments 57a that “fill” the areas between the tip 57 and the rounded surfaces defining the end opening 62 of the housing 60. Thus, the segments 57a have a planar portion adjacent the tip 57 and a rounded portion adjacent the housing 60. It is understood that in one embodiment, fill segments 57a are integral with the latch bolt 50.

Further, as illustrated in FIG. 37, the width (WT) of the tip 57 of the latch bolt 50 and the width of the portion 57b of the latch bolt 50 adjacent the tip 57 are generally greater than the width (WB) of the bulk of the latch bolt 50. Thus, even though the main portion of the latch bolt 50 is sized to fit within the tilt-latch housing 60 having a smaller configuration to fit within smaller pockets of the top rail 20, the width (WT) of the tip 57 can have a conventional width that provides a suitable engagement surface for the guide rails 16. In another embodiment, the tip 57 of the latch bolt 50 may be substantially larger than the rest of the latch bolt 50 or even larger than the housing 60 to provide a larger engagement surface (EW) because the latch bolt tip 57 need not fit completely into the housing 60. This enlarged design is shown schematically by the dotted lines in FIG. 37. The housing 60 can be designed with a slot or gap (not shown) therein to permit retraction of a latch bolt tip 57 much wider than the housing 60. In such case, the flexible stile engaging member 64b may be suitably relocated on the housing 60. The hole provided in the stile would also be enlarged to accommodate the enlarged nose or tip 57. Thus, the latch bolt 50 and housing 60 can be designed to be very small, while the tip 57 of the latch bolt 50 can be of a different size. As shown in FIGS. 35 and 37, the latch bolt 50 has a rounded top surface 49 that is dimensioned similarly to the rounded housing 60. Additionally, in one embodiment, the latch bolt 50 has a stop 95a (FIG. 38) that abuts an abutment surface 95b of the housing 60 to prevent the latch bolt 50 from being pushed out of the housing 60 farther than is necessary for engaging the guide rail 16. It is understood that the latch bolt 50 and the cavity of the housing 60 may be differently shaped, and may include different features to prevent rotation of the latch bolt 50 within the housing 60.

The connector 52 connects to the latch bolt 50, such as by a snap-fit connection 55, as illustrated in FIGS. 4-14 and 38. The latch bolt 50, as shown, has a recess 55a on the underside of the latch bolt 50 to receive the end 56 of the connector 52 and create the snap-fit connection 55. As illustrated in FIGS. 21-23 and 38, the second end 56 of the connector 52 has several resilient bracing arms 53 extending therefrom. When the connector end 56 is snapped into the latch bolt 50, the bracing arms 53 exert directional forces on the latch bolt 50, thus bracing the connector 52 against excessive movement during operation of the assembly 30. Also, the top wall of the housing 60 covers the snap fit connection 55 when the latch bolt 50 is extended, resisting disconnection of the connector 52 from the latch bolt 50.

The integrated assembly 30 includes a connector 52 that connects the sash lock mechanism 32 to the tilt latch mechanism 31. The connector 52 has a substantially rigid or semi-flexible, elongated body 21 with a first end 54 connected to the sash lock mechanism 32 and a second end 56 connected to the tilt latch mechanism 31. The first end 54 of the connector 52 is operably associated with the pawl 72, such as by engaging the appending member 78 of the pawl 72. As described above, the connector 52 has the hitch 59 that engages the hook 77 on the appending member 78 of the pawl 72 and the retaining structure that includes the flexible lip 59a and the protrusion 59b. The second end 56 of the connector 52 is connected to the latch bolt 50, such as by passing through the rear opening 68 of the housing 60 and forming a snap-fit connection 55 with the latch bolt, as described above and illustrated in FIGS. 4-14 and 38. As also described above, when the connector end 56 is snapped into the latch bolt 50, the bracing arms 53 exert directional forces on the latch bolt 50, thus bracing the connector 52 against excessive movement during operation of the assembly 30. Additionally, the bracing arms 53 exert a downward force or torque on the connector 52, tending to push the first end 54 of the connector downward. Pushing the first end 54 of the connector 52 downward helps assure that the connector 52 remains in the proper position for connection to the sash-lock mechanism 32, facilitating a user in making a blind connection between the connector 52 and the sash lock mechanism 32. However, the positioning of the bracing arms 53 permits a certain amount of lateral pivoting of the connector 52, which enables mounting in different positions, as described below.

In one exemplary embodiment, the connector 52 is a substantially rigid or semi-flexible connecting rod having an elongated body 21. The rigid or semi-flexible connector 52 has a bend in the middle to prevent interference between the connector 52 and mounting structure for the sash lock mechanism 32. Further, the connector 52 has a curved arm 51 at the first end 54 that engages the eccentric cap 35 of the sash lock mechanism 32 to retract the latch bolt 50 slightly, as described below. The non-flexible nature of the connector 52 provides advantages over prior connecting means that utilize flexible cords or bands. For example, the non-flexible connector 52 has increased dimensional stability, so the connector 52 doesn't stretch over time and affect the functioning of the integrated assembly 30. However, in another embodiment, a flexible cord or band may be used as the connector 52 of the present invention.

The length of the connector 52 used with the integrated assembly 30 can vary as desired, for example, in order to mount the integrated assembly 30 in windows of different dimensions. In one embodiment, the connector 52 has a fixed length, and thus, different connectors 52 having different lengths can be produced and selected for use as desired. In other words, the connector 52 selected from a group consisting of a plurality of connectors 52 having different lengths.

In one exemplary embodiment, the mounting length between the center of rotation of the cam 44 (i.e., the center of the shaft 38) and the stile outer surface 24a is 15-25% of the total length of the top rail 20 when the integrated assembly 30 is mounted in the sash window 12. This positioning maximizes the strength of the top rail 20. In one configuration, the mounting length is 4.5 in. (±1 in.), and the corresponding length of the connector 52 is 3.520 in. (±1 in.). In another configuration, the mounting length is 7.75 in. (±1 in.), and the corresponding length of the connector 52 is 6.770 in. (±1 in.). In a third configuration, the mounting length is 11 in. (±1 in.), and the corresponding length of the connector 52 is 10.020 in. (±1 in.). As described above, a nearly infinite number of other configurations are possible. The connector 52 lengths are selected based on window size and to enhance overall manufacturability, strength, and user operation.

The components of the integrated assembly 30 of FIGS. 1-38 are connected as shown in FIGS. 4-14. First, the sash lock mechanism 32 and the tilt latch assembly 31 are assembled. Assembly of the tilt latch mechanism 31 includes inserting the latch bolt 50 and the spring 63 into the housing 60 in the required positions. To assemble the sash lock mechanism, the shaft 38 of the actuator handle 36 is inserted down through the opening 81 in the housing 82 and is connected to the cam 44, extending down through the cam. The pawl 72 is then inserted onto the end of the shaft 38, and the cap 35 is connected over the pawl 72 at the tip of the shaft 38. A washer, grommet, bearing, or similar component (not shown) may also be inserted between the components of the sash lock mechanism 32. Finally, the connector 52 is connected at the second end 56 to the latch bolt 50 and at the first end 54 to the appending member 78 of the pawl 72 to operably connect the tilt latch mechanism 31 to the sash lock mechanism 32. As discussed in greater detail below, the tilt-latch mechanism 31 and connector 52 may be inserted into the top rail 20 and then the sash lock mechanism 32 is connected to the connector 52 and mounted on the top rail 20.

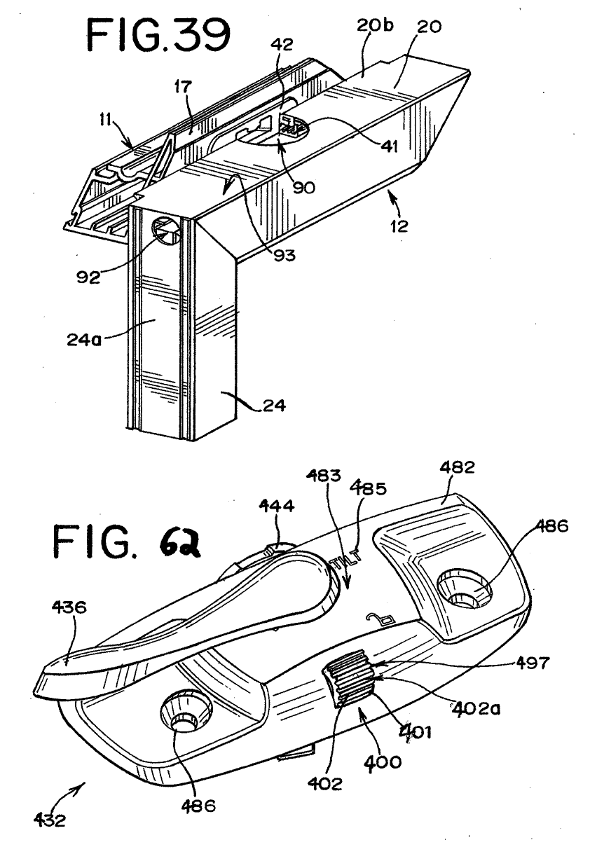

A variety of different methods can be used to mount the integrated assembly 30 in the sash window 12, as determined by the user. In one embodiment, the integrated assembly 30 is mounted within a cavity 90 in the sash window 12. The cavity 90 is in communication with a first opening 91 in the top sash rail 20 for the sash lock mechanism 32 and a second opening 92 in the stile 24,26 for the tilt latch mechanism 31, as illustrated in FIG. 39. The second opening 92 extends through the vertical outer surface 24a of the stile 24 and is located entirely below the horizontal outer surface 20b of the top rail 20. It is understood that in some embodiments, the second opening 92 may extend into a top surface 20b of the top rail 20 as well, depending on the configuration of the tilt latch mechanism 31. Generally, the user forms the openings 91,92 in the sash window 12 by cutting, drilling, routing etc., but it is contemplated that sash windows 12 could be manufactured with pre-formed openings 91,92. Advantageously, the rounded shape of the tilt latch housing 60 permits the tilt latch mechanism 31 to be mounted in a circular opening 92 in the stile 24,26. The circular opening 92 can be routed or drilled using a corresponding bit of suitable diameter, which is quicker, more precise, and greatly simplified with respect to prior tilt latch mounting procedures that often require stile openings of complex geometry. Further, the tilt latch mechanism 31 does not require an opening that extends through both the stile 24,26 and the top surface 20b of the top rail 20, which can lessen the overall strength of the top sash rail 20 and produce an undesirable appearance for some applications, as do many prior tilt latches. Thus, the tilt-latch mechanism 31 is mounted within the top rail 20 by an opening in the stile 24,26 wherein the top surface 20b of the top rail 20 is smooth and is not compromised by a top opening.

First, the second end 56 of the connector 52 is snapped to the latch bolt 50 of the assembled tilt latch mechanism 31 to form a snap fit connection 55, after the latch bolt 50 is pulled backward in the housing 60 to make the recess 55a accessible. Then, as can be appreciated from FIGS. 2 and 2A, the tilt latch mechanism 31 and connector 52 are inserted through the second opening 92 and into the cavity 90 in the sash window 12. When the tilt latch mechanism 31 is inserted into the opening 92, the tab 64b flexes upward upon contact with the stile 24,26 and snaps back into position upon clearing the wall of the stile 24,26. The flange 64a and the tab 64b then cooperate to hold the tilt latch mechanism 31 in place within the sash window 12. Thus, the tilt latch mechanism 31 can be mounted within the sash window 12 without the use of fasteners. At this point, the first end 54 of the connector 52 is exposed within the first opening 91. The assembled sash lock mechanism 32 is likewise installed in the first opening 91 so that the housing 82 rests upon the top surface 20b of the top sash rail 20 and a portion of the sash lock mechanism 32 extends into the cavity 90 in the sash window 12. The sash lock mechanism 32 should be positioned so that the appending member 78 of the pawl 72 is in position to engage the hitch 59 of the connector 52. In one embodiment, the sash lock housing 82 is fastened to the top sash rail 20 by screws or other fasteners (not shown). Once the tilt latch mechanism 31 and the sash lock mechanism 32 are in place, the connector 52 is connected to the appending member 78 of the pawl 72 by simply rotating the actuator handle 36, which causes the pawl 72 to rotate, forcing the hook 77 of the pawl 72 to snap into the hitch 59 on the first end 54 of the connector 52. Another integrated assembly may be mounted at the other side of the sash window 12 in a similar manner. The order of the steps in the mounting method described above may be varied, and further, the integrated assembly 30 may be mounted using a different method.

The first opening 91 is positioned at a first location and the second opening 92 is positioned at a second location remote from the first location, so that, when mounted, the sash lock mechanism 32 is positioned at the first location and the tilt latch mechanism 31 is positioned at the second, remote location. The positioning of the openings 91,92 on the sash window 12 can vary, based on several factors, including user choice and the size of the components of the integrated assembly 30. Generally, the tilt latch opening 92 can be moved an appreciable lateral distance without necessitating a change in components of the integrated assembly 30. The broken lines in FIG. 2A illustrate two potential positions to which the tilt latch opening 92 and the tilt latch mechanism 31 may be moved. The structure of the snap fit connection 55, particularly the bracing arms 53 of the connector 52, permit the connector 52 to pivot a certain distance laterally, creating a variety of different positions for connection. Thus, the lateral displacement between the tilt latch mechanism 31 and the sash lock mechanism 32 can vary. Further, the bracing arms 53 embody means and structure for resisting vertical movement and pivoting of the connector 52 while permitting lateral movement and pivoting of the connector 52.

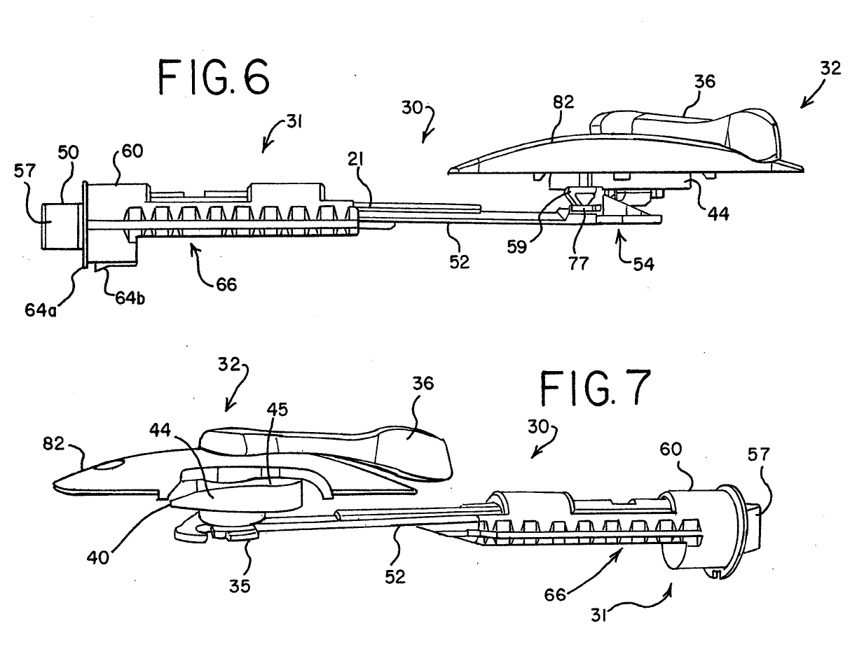

When the integrated assembly 30 is mounted within the sash window 12, the sash lock mechanism 32 is located partially above the top wall 93 of the top sash rail 20 and partially below the top wall 93, as shown in FIGS. 3 and 3A. Mounting the sash lock mechanism 32 with a shallow mounting depth is advantageous because it allows the integrated assembly 30 to be mounted using a relatively shallow cavity 90. On the other hand, mounting the sash lock mechanism 32 with a large mounting depth is often considered more visually appealing because such a mounting generally results in a lower profile. Thus, the mounting configuration of the integrated assembly 30 offers a compromise, having a relatively shallow cavity 90 while still presenting a relatively low profile. As shown in FIGS. 3 and 3A, the integrated assembly 30 is mounted so the cam 44 is approximately level with the top wall 93 of the top sash rail 20. Thus, a portion 44a of the cam 44 is above the top sash rail 20 and a portion 44b of the cam 44 is below the top sash rail 20. It is understood that the mounting depth can be varied by altering the size, shape, and spacing of the components of the sash lock mechanism 32, including by altering the shape and/or curvature of the sash lock housing 82. Also, as shown in FIGS. 6, 7, 10, and 14, because the bottom surface 82a of the sash lock housing 82 rests on the top wall 93 of the top sash rail 20, the sash lock mechanism 32 is configured so that a portion 44a of the cam 44 is above the bottom surface 82a of the sash lock housing 82 and a portion 44b of the cam 44 is below the bottom surface 82a of the sash lock housing 82.

The keeper 42 is mounted on the bottom sash rail 17 of the upper sash window 11, within an opening cut into the side surface of the bottom sash rail 17, as shown in FIGS. 1 and 2. To mount the keeper 42, the opening is cut into the bottom sash rail 17 in the proper shape and the keeper 42 is inserted into the opening. The keeper 42 may be held in place by screws or other fasteners (not shown). The positioning of the cam 44 level with the top wall 93 of the top sash rail 20 of the bottom sash window 12 makes this positioning of the keeper 42 advantageous. In addition, this positioning of the keeper 42 presents a lower profile as compared to positioning the keeper 42 on top of the bottom sash rail 17.

As described above and illustrated in FIGS. 4-14, the assembly 30 is operable between a locked position, an unlocked position, and a tiltable position. The actuator handle 36 of the present invention is operable between locked, unlocked and tiltable positions, adjusting the assembly 30 between the three positions. The sash lock housing 82 has indicia 85 thereon to indicate the positions of the actuator handle 36. It is also contemplated that the actuator handle 36 can include some indicia thereon for assisting a user during operation. When the actuator handle 36 is in the locked position, illustrated in FIGS. 7-10, the locking member 40 of the cam 44 engages the keeper 42 (See FIGS. 15A and 15B) and the latch bolt 50 is in the outwardly-extended position, engaging the guide rail 16. Accordingly, the sash lock mechanism 32 is locked wherein the cam 44 is locked with the keeper 42. Also, the latch bolt 50 is in its extended position and engaged with the guide rail 16. Thus, the sash window 12 is prevented both from sliding vertically with respect to the upper sash window to an open position and from tilting from the master frame 14. In this position, the abutment member 41 of the cam 44 and the tab 80 of the pawl 72 are not engaged with each other, and the cam 44 moves freely and independently of the pawl 72.

When the actuator handle 36 is moved from the locked position to the unlocked position, shown in FIGS. 4-6, the actuator handle 36 and the cam 44 are rotated to a first angle α from the locked position. This rotation disengages the locking member 40 from the keeper or locking bracket 42, permitting the sash window 12 to vertically open by sliding within the window frame 14. However, the latch bolt 50 remains outwardly extended into the guide rail 16, and thus, the sash window 12 continues to be prevented from tilting. In the embodiment illustrated in FIGS. 4-6, in the unlocked position, the tab 80 of the pawl 72 is still not yet abuttingly engaged by the cam 44, and the pawl 72 abuttingly engages the cam 44 upon slight further rotation. However, the integrated assembly 30 may be modified so the cam 44 and the pawl 72 abuttingly engage prior to the actuator 36 reaching the unlocked position, simultaneously with the unlocked position, or significantly after the actuator 36 passes the unlocked position. Additionally, a spring within the latch bolt housing 60 may bias the cam 44 toward the unlocked position.

When the actuator arm 36 is moved from the unlocked position to the tiltable position, shown in FIGS. 11-14, the actuator handle 36 and the cam 44 are rotated to a second angle β from the locked position, wherein the second angle β is greater than the first angle α. The second angle β is greater than 180° in one embodiment, shown in FIG. 13. In the tiltable position, the locking cam 44 remains disengaged from the keeper 42, still permitting the sash window 12 to vertically open. However, the cam 44 abuttingly engages the tab 80 extending from the pawl 72, causing the pawl 72 to rotate in unison with the cam 44. Rotation of the pawl 72 pulls the connector 52, which in turn pulls the latch bolt 50 toward the retracted position. In this retracted position, the latch bolt 50 is released from the guide rail 16, permitting the sash window 12 to tilt about the pivot corner 15. During this movement, the connector 52 is substantially linearly displaced. At some point between the first angle α and the second angle β and prior to the point where the abutment member 41 abuttingly engages the pawl 72, the eccentric cap 35 rotates to engage the curved arm 51 of the connector 52. Further rotation of the cap 35 exerts a camming force on the connector arm 51, pulling the connector 52 slightly, which in turn retracts the latch bolt 50 slightly. This permits the integrated assembly 30 to begin retraction of the latch bolt 50 prior to the point where the abutment member 41 of the cam 44 abuttingly engages the pawl 72.

As described above, the cam 44 contains means 94 for selectively preventing movement of the integrated assembly 30 to the tiltable position, such as the enlarged or eccentric portion 94 of the cam 44 that is rotationally opposite of the locking member 40. When the integrated assembly 30 is in the unlocked position, and a user wishes to move the actuator handle 36 to the tiltable position, the eccentric portion 94 abuts the keeper 42, preventing rotation of the cam 44. In order to rotate the actuator handle 36 and cam 44 further, the user must lift the sash window 12 slightly, to allow the eccentric portion 94 to clear the keeper 42 and the bottom rail 17, in one embodiment, and the actuator handle 36 can thus be moved to the tiltable position. It is understood that the bottom rail 17 could be modified or the keeper 42 positioned such that as soon as the cam 44 passes above the keeper 42, the actuator handle 36 can be moved to the tiltable position.

Additionally, in one embodiment, the actuator handle 36 and the sash lock housing 82 have cooperating structure to indicate the position of the integrated assembly 30 to the user. As shown in FIGS. 28-29, the housing 82 has an annular ledge 87 having two protrusions 88 positioned at points around the ledge 87, and the actuator handle 36 has a projection 89 on the lower side. The first protrusion 88a is located proximate the fully locked position of the actuator handle 36, and the second protrusion 88b is located proximate the unlocked position of the actuator handle 36. During rotation of the actuator handle 36, the projection 89 of the actuator handle 36 engages the protrusion 88 of the housing 82, creating momentarily greater resistance to rotation of the actuator handle 36. When the actuator handle 36 clears the protrusion 88, the user feels a “click” which, due to the relative positions of the protrusions 88, indicates a position of the actuator handle 36 to the user. Accordingly, the tactile feel created by the first protrusion 88a indicates when the actuator handle 36 has moved to or from the fully locked position. Similarly, the tactile feel created by the second protrusion 88b indicates when the actuator handle 36 has moved to or from the unlocked position. Thus, the actuator handle 36 and the housing 82 create a tactile feel for the user to indicate positions of the integrated assembly 30.

Viewed another way, the assembly 30 is moveable through a first range of angular movement, where movement of the actuator handle 36 rotates the rotor 44, and a second range of angular movement, where the rotor 44 abuttingly engages the pawl 72 such that movement of the actuator handle 36 rotates the rotor 44 and the pawl 72 together. As described above, the locking member 40 is disengaged from the keeper 42 within the first range of angular movement, and prior to the abutting engagement between the rotor 44 and the pawl 72. Additionally, the actuator handle 36 is moveable among a first position, where the cam or rotor 44 does not abuttingly engage the pawl 72 and the assembly is in the locked position, a second position where the cam 44 abuttingly engages the pawl 72 and the assembly is in the unlocked position, and a third position where the cam 44 abuttingly engages the pawl 72 and the connector 52 retracts the latch bolt 50 so the assembly is in the tiltable position. As described above, the locking member 40 is disengaged from the keeper 42 before the actuator handle 36 reaches the second position. It is understood that the assembly 30 and the actuator 36 may have several positions which are “locked,” “unlocked,” and “tiltable” positions, dictated by the function of the window at the respective position. It is also understood that the sequence of mechanical interactions within the assembly 30 may be varied. Thus, depending on the configuration of the assembly 30, there may be additional positions where, for example, the assembly is in the locked position and the cam 44 is already abuttingly engaging the pawl 72; or, in an alternate embodiment of the assembly, where the assembly 30 is in the unlocked position but the cam 44 has not yet abuttingly engaged the pawl 72.

When operating the actuator handle 36 in reverse to the above, the integrated assembly 30 is moved from the tiltable position to the unlocked position, and the actuator handle 36 and cam 44 are rotated from the second angle β back to the first angle α. The locking member 40 remains disengaged from the keeper 42, still permitting the sash window to vertically open. As the actuator handle 36 and the cam 44 move toward the unlocked position, the latch bolt 50 moves back to the outwardly-extended position due to the bias created by the spring 63. This movement is enabled because the pawl 72 is no longer being rotatably biased by the cam 44. In one embodiment, this action is done automatically when the handle 36 is released by the user, because the force of the spring 63 not only forces the latch bolt 50 to the outwardly-extended position, but pulls on the connector 52, causing the cam 44 and the handle 36 to rotate back to the unlocked position (angle α). At some point within this range of movement, prior to the full extension of the latch bolt 50, the abutting engagement between the abutment member 41 of the cam 44 and the tab 80 of the pawl 72 ceases. When the integrated assembly 30 reaches the unlocked position, the latch bolt 50 is once again fully extended, and the sash window 12 is prevented from tilting when in the closed position. It is understood that the integrated assembly 30 can be returned to the unlocked position while the window 12 is still tilted open. Due to the beveled surface of the latch bolt tip 57, the window 12 can be shut while the integrated assembly 30 is in the unlocked position, as contact with the window frame 14 will force the latch bolt 50 back into the housing 60 until the latch bolt tip 57 is aligned with the guide rails 16, when the spring 63 forces the latch bolt 50 back outward. The forcing of the latch bolt 50 inward during this action will cause the pawl 72 to rotate, but since the pawl 72 and the cam 44 are engaged only for rotation in one direction, this movement of the pawl 72 will not rotate the cam 44. As the actuator handle 36 and the cam 44 further move toward the locked position, the cam 44 rotates to engage the keeper 42. When the integrated assembly 30 is returned to the locked position, the locking member 40 engages the locking bracket on the keeper 42, preventing the sash window 12 from opening.

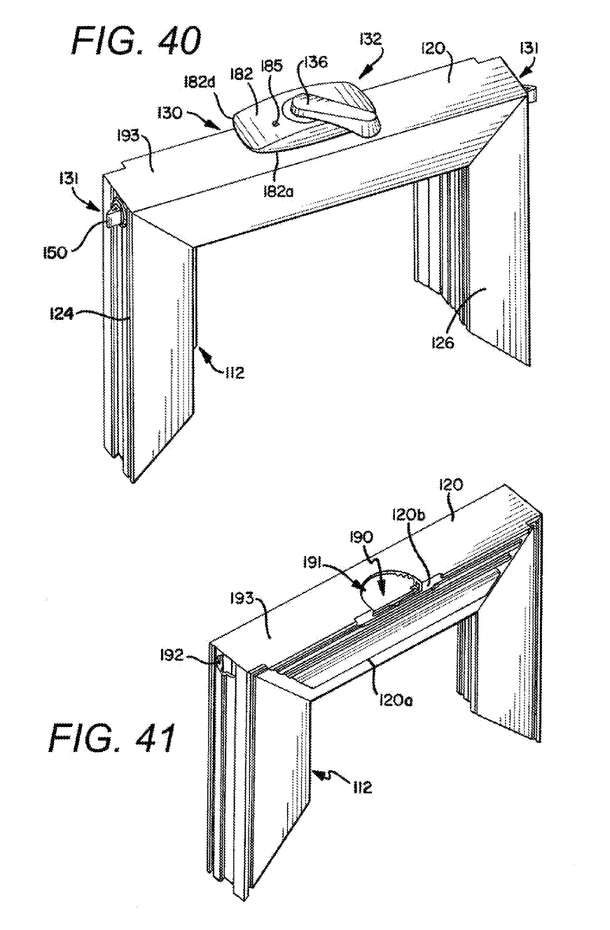

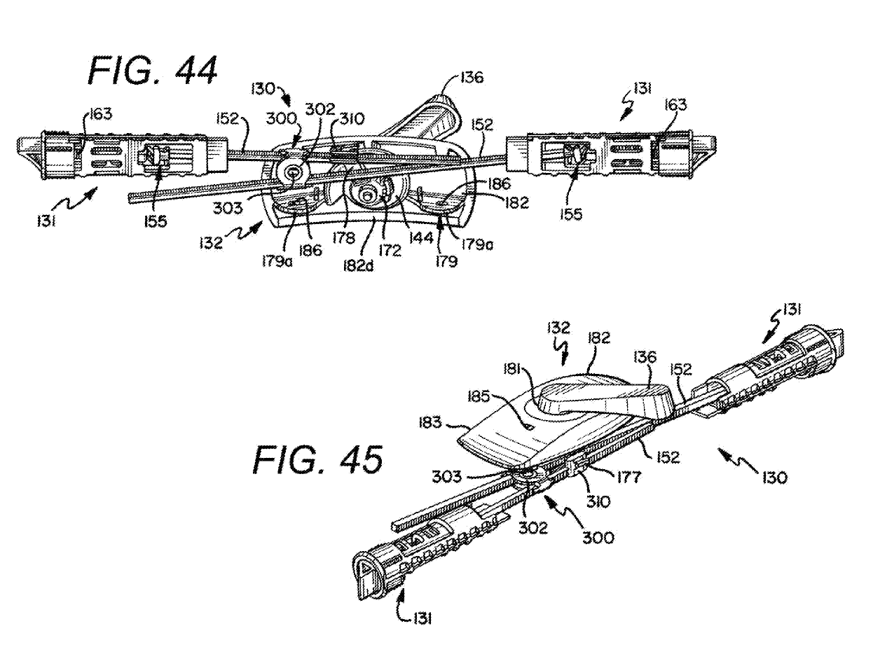

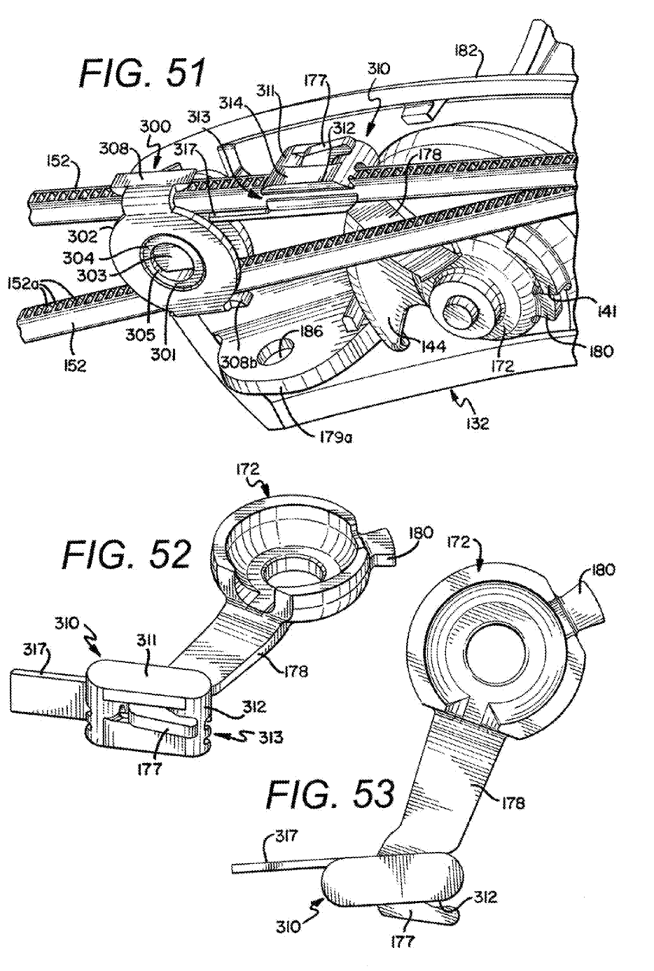

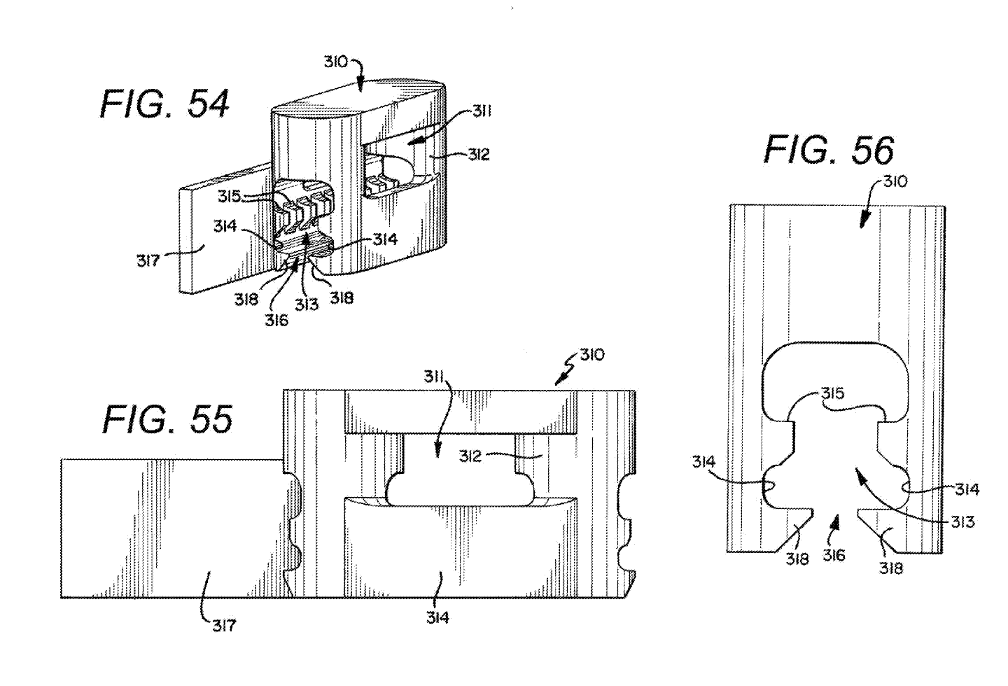

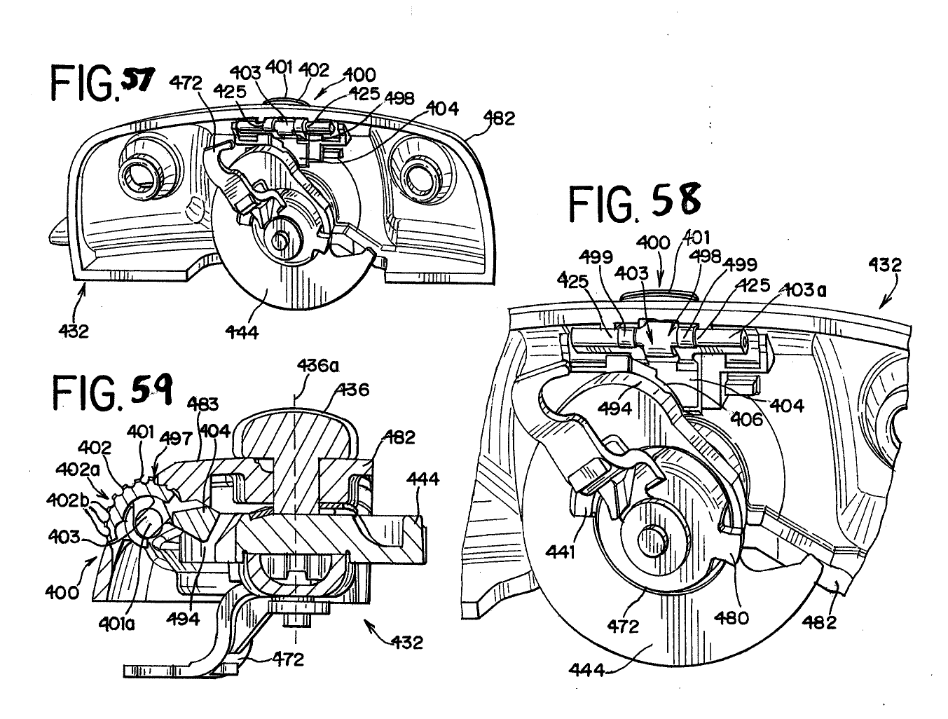

Another embodiment of an integrated tilt latch and sash lock assembly 130 is illustrated in FIGS. 40-56. Most of the components of the integrated assembly 130 shown in FIGS. 40-56 are the same or similar to those of the integrated tilt latch and sash lock assembly 30 as described above and shown in FIGS. 1-38, and similar components are consistently numbered using the “100” series of reference numbers. As illustrated, the integrated assembly 130 is adapted for use in a sash window 112 and is adapted to be mounted in the top sash rail 120 of the window 112. The integrated assembly 130 includes a sash lock mechanism 132 that is operable to control two tilt latch assemblies 131 through the use of a drive mechanism 300. It is understood that the integrated assembly 130 is able to be used with a single tilt latch assembly 131, such that the drive mechanism 300 may not be necessary. Accordingly, as illustrated in FIGS. 40-41, the top sash rail 120 can be configured with a single opening 191 for the sash lock mechanism 132 and two openings 192 for the tilt latch mechanisms 131, to allow functioning of these respective components within the internal cavity 190 of the top sash rail 120.

The sash lock mechanism 132 of the integrated assembly shown in FIGS. 40-56 is similar in structure to the sash lock mechanism 32 described above, and includes an actuator arm or handle 136 connected to a cam or rotor 144 which is operably connected to a pawl 172, and a housing 182 supporting the other components of the sash lock mechanism 132. The handle 136, rotor 144, and pawl 172 of the sash lock mechanism 132 are similar both structurally and functionally to the handle 36, rotor 44, and pawl 72 described above. Additionally, the sash lock mechanism 132 operates similarly to the sash lock mechanism 32 described above. The housing 182, which is shown in FIGS. 40, 42-45, and 51, is configured differently than the housing 82 described above, as the housing 182 has internal mounting structure configured for internal connection to the top sash rail 120 of the window 112. In contrast, the housing 82 described above has externally-visible mounting structure configured for mounting to the top sash rail 20 by connection to the top surface of the sash rail 20.

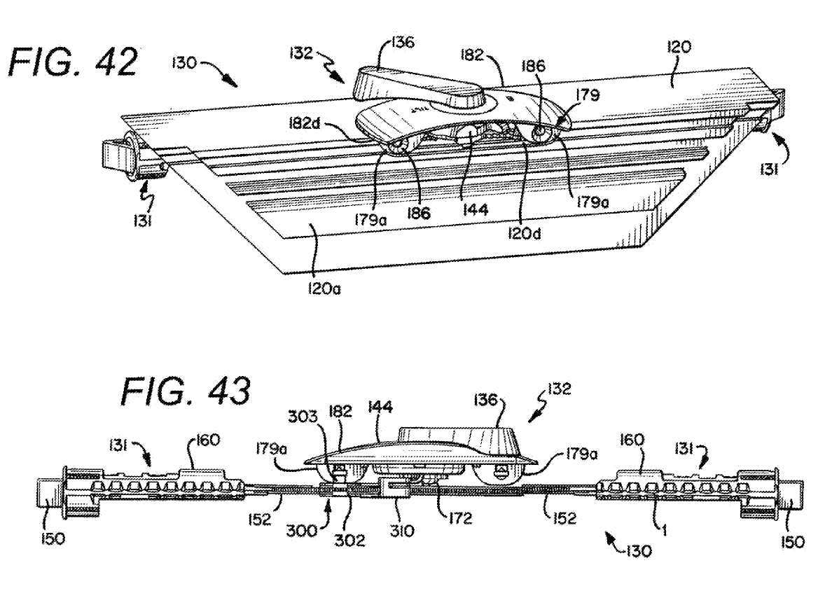

The housing 182 is adapted to be mounted on the top sash rail 120 to mount the sash lock mechanism 132 to the sash window assembly 10. In one exemplary embodiment, the housing 182 is made of cast metal. The housing 182 has an opening 181 therein and indicia 185 on the top surface 183 thereof. As seen in FIGS. 42-44, the housing 182 has an internal mounting structure 179 for mounting to the sash rail 120 by connection to a non-exposed surface (such as a side surface or an internal surface) of the sash rail 120. In the embodiment illustrated, the internal mounting structure includes a pair of flanges 179a connected to an internal surface of the housing 182 and depending from the housing 182. Each flange 179a has a screw aperture 186 for insertion of fasteners (not shown) to connect the housing 182 to the top sash rail 120. As shown in FIG. 42, the flanges 179a are positioned to allow connection of fasteners to the unexposed rear surface 120a of the top sash rail 120. Additionally, the flanges 179a are positioned inwardly of the outer edges 182a of the housing 182 that sit upon the top surface 193 of the top rail 120 of the sash window 112, and extend below the outer edges 182a. As seen in FIGS. 41 and 42, the rear surface 120a of the sash rail 120 includes a recess 120b that receives the flanges 179a so that the flanges 179a do not protrude from the rear surface 120a and do not interfere with opening and closing the window 112. Connection to the unexposed rear surface 120a of the sash rail 120 allows for concealing the fasteners, which provides an aesthetically pleasing appearance, since no mounting structure is externally visible. The housing 182 further includes an overhanging portion 182d that extends rearwardly from the flanges 179a and past the rear surface 120a of the sash rail 120 when mounted, as shown in FIGS. 40 and 42. In this embodiment, the overhanging portion 182d is formed by an arched rear edge of the housing 182. This overhanging portion 182d provides additional concealment of the mounting structure and a pleasing aesthetic appearance.

In other embodiments, the housing 182 may include a different internal mounting structure, and may be configured for connection to an internal surface of the sash rail 120 to provide non-exposed mounting. The housing 182 further has additional features similar to those described above with respect to the integrated assembly 30 illustrated in FIGS. 2-38. It is understood that various features of the integrated assembly 130, such as the drive mechanism 300 described below, can be incorporated for use with a sash lock housing that has similar mounting structure to the housing 82 described above.

The tilt latch mechanisms 131 of the integrated assembly 130 shown in FIGS. 40-56 are generally similar to the tilt latch mechanisms 31 of the integrated assembly 30 described above and shown in FIGS. 2-38. The tilt latch mechanisms 131 illustrated in FIGS. 42-45 and 50 generally includes a latch bolt 150 disposed within a tilt latch housing 160 and a means 163 for biasing the latch bolt outwardly, as described above. Additionally, the latch bolts 150 and connectors 152 are adapted for a snap-fit connection 155, similarly to the snap fit connection 55 between latch bolt 50 and connector 52 described above, as seen in FIG. 50.

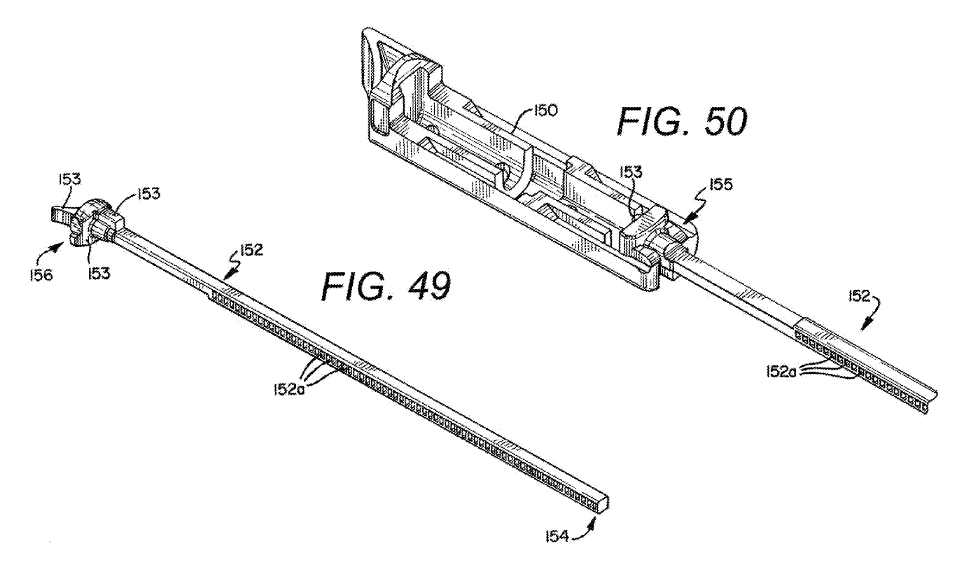

An example of a connector 152 of the integrated assembly 130 is shown in greater detail in FIGS. 49 and 50. One end 156 of the connector 152 is adapted for snap-fit connection to the latch bolt 150, by fitting into a recess 155a on the latch bolt, and the connector 152 has resilient bracing arms 153 for bracing the snap-fit connection 155. Additionally, as described above, the connector 152 has a plurality of teeth 152a, which can engage teeth 301a of a pinion gear 301 to be further described. Further, unlike the connector 52 described above, the illustrated embodiment of the connector 152 does not have a hitch or other such connection for engaging the pawl 172. Rather, a connection member 310 is provided to operably connect the pawl 172 to the connector 152, as described in greater detail below. It is understood that the connector 152 can be configured for direct connection to the pawl 172 in other embodiments, such as by using the hitch structure 59 described above.

The integrated assembly 130 shown in FIGS. 40-56 includes the drive assembly 300, which enables the single sash lock mechanism 132 to operate the two tilt latch mechanisms 131. In the embodiment illustrated in FIGS. 43-48 and 51, the drive assembly 300 has a rack-and-pinion configuration, which generally includes a rotatable pinion gear 301 that engages the two connectors 152, each of the connectors 152 having a plurality of teeth 152a for engaging the pinion gear 301. Through the rack-and-pinion configuration, movement of one connector 152 causes simultaneous movement of the other connector 152, allowing operation of both connectors 152 by the sash lock mechanism 132.

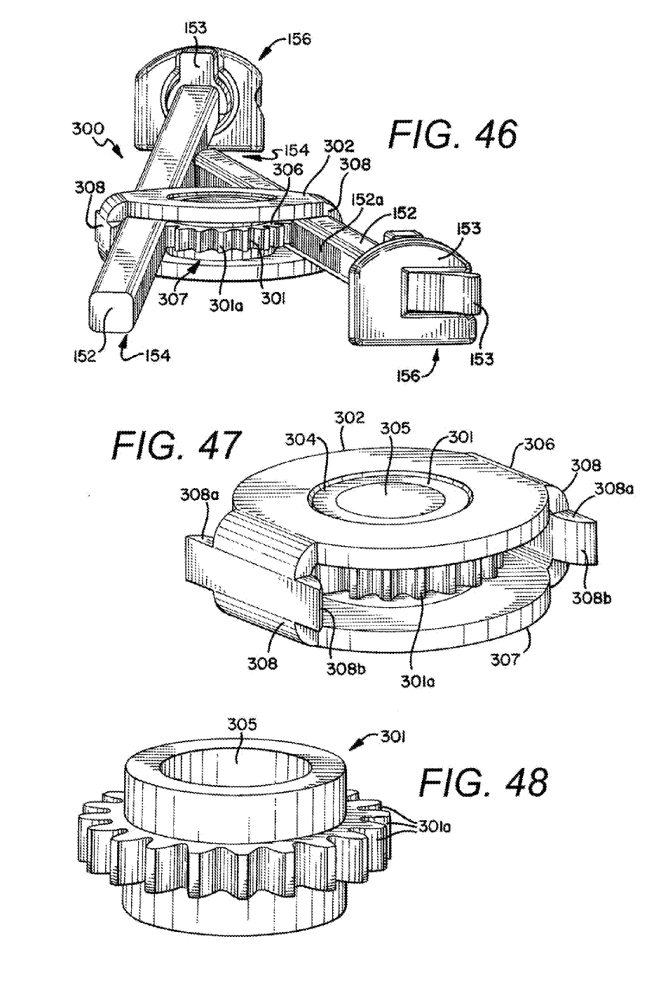

One illustrative embodiment of the pinion gear 301 is shown in more detail in FIGS. 46-48, and is mounted within a pinion housing 302. The pinion housing 302 is connected to the sash lock housing 182 and the pinion gear 301 is free to rotate within the pinion housing 302. As shown in FIGS. 43-45 and 51, the pinion gear 301 and pinion housing 302 are mounted on a peg 303 depending from the inner surface of the sash lock housing 182. The pinion housing 302 is fixedly connected to the peg 303, and the peg 303 extends through an opening 304 in the pinion housing 302 to establish this connection. The peg 303 and/or the pinion housing 302 may contain additional retaining structure to secure the connection therebetween in some embodiments. Likewise, the peg 303 extends through an opening 305 in the pinion gear 301 such that the pinion gear 301 can freely rotate about the peg 303, providing a rotational axis for the pinion gear 301. The pinion gear 301 has a plurality of gear teeth 301a that engage the teeth 152a on the connectors 152, so that rotation of the pinion gear 301 operates to transfer movement between the connectors 152.

The pinion housing 302 has an internal cavity 306 that receives the pinion gear 301 such that the pinion gear 301 can freely rotate within the pinion housing 302, as shown in FIGS. 46, 47, and 51. The pinion housing 302 also has opposed side openings 307 and opposed side walls 308, as illustrated in FIGS. 46 and 47. The side openings 307 to permit the connectors 152 to extend through the housing cavity 306 and engage the pinion gear 301, and the side walls 308 hold the connectors 152 in position to ensure that the teeth 152a of the connectors 152 remain in engagement with the teeth 301a of the pinion gear 301. The side walls 308 further include guides 308a with contoured surfaces 308b to further guide and assist the movement of the connectors 152 through the pinion housing 302.

As shown in FIG. 43, the pinion gear 301 and pinion housing 302 have a low-profile configuration, such that the pinion gear 301 and pinion housing 302 do not extend appreciably lower than other lowermost components of the sash lock mechanism 132, such as the pawl 172. This permits the sash lock mechanism 132 and the drive assembly 300 to fit within the internal cavity 190 of the top sash rail 120 without necessitating any change in the dimensions or internal configuration of the top sash rail 120. The pinion housing 302 may be a single unitary structure or multiple components connected together.

A connection member 310 forms an operable connection between the pawl 172 of the sash lock mechanism 132 and the connector 152, to allow the pawl 172 to move the connector 152. In the embodiment shown in FIGS. 43-45 and 51-56, the connection member 310 is adapted for connection to the appending member 178 of the pawl 172 and is also adapted for connection to the connector 152 by engaging the teeth 152a of the connector 152. In the illustrated embodiment, the connection member 310 has a receiver 311 therein to receive the hook 177 on the appending member 178 of the pawl 172. Additionally, the hook 177 engages a wall 312 adjacent the receiver 311 to exert force on the connection member 310. In this embodiment, the wall 312 of the connection member 310 has a smoothly curved contour, to match the curved contour of the engaging surface of the hook 177. It is understood that the connection member 310 may be designed differently for connection to the pawl 172, such as if the pawl 172 has a different type of connecting structure other than the hook 177.

The illustrated embodiment of the connection member 310 also has an internal passage 313 therethrough for receiving a portion of the connector 152 therethrough, to connect the connector 152 to the connection member 310. The connection member 310 further has opposed side walls 314 defining the passage 313, and the side walls 314 have teeth 315 thereon for engaging the teeth 152a of the connector 152 to connect the connection member 310 to the connector 152. The teeth 315 of the connection member 310 and the teeth 152a interlock to form a secure connection. The connection member 310 further includes tabs or ledges 318 on the bottom of the passage 313 to retain the connector 152 in the passage 313. In this embodiment, the connection member 310 is made of a resilient material, and has a gap 316 at the bottom, to allow the side walls 314 to be flexed slightly outward to separate the teeth 152a, 315 for adjusting the connection between the connection member 310 and the connector 152. In another embodiment, the teeth 152a of the connector 152 and/or the teeth 315 of the connection member 310 may be angled to create more secure interlocking between the teeth 152a, 315, and may angled in opposite directions.

The illustrated embodiment of the connection member 310 further has a spacer member in the form of a tab 317 extending from an edge of the connection member 310. The spacer member 317 is configured to correspond to the approximate distance that the connection member 310 should be spaced from the pinion housing 302 when the integrated assembly is in the locked and/or unlocked position, in order to facilitate mounting of the connection member 310. Accordingly, when a person is connecting the connection member 310 to the connector 152, the connection member 310 can be adjusted until the spacer member 317 is close to the pinion housing 302, thus ensuring that the connector 152, the pawl 172, and the connection member 310 will be in proper configuration and alignment for operation of the integrated assembly 130. As a result, little to no measurement, trial-and-error adjustment, or calibration is necessary on the part of a person installing the integrated assembly 130. It is understood that the integrated assembly 130 may allow room for error, such that the necessary distance between the spacer member 317 and the pinion housing 302 may have a certain error tolerance. It is further understood that the connection member 310 may be modified to use a spacer member 317 of a different length for connecting to a different embodiment of the sash lock mechanism 132. In another embodiment, the connection member 310 may have a different type of spacer member, which may use a different component for reference other than the pinion housing 302.

The connection member 310 is adjustable, and can be connected to the connector 152 in a number of different positions, as described above. Because this embodiment of the connector 152 is adjustable and has no set structure for connection to the pawl 172 (such as the hitch 59 described above), a single connector length can be used for mounting the integrated assembly 130 in a variety of sash rails having different lengths. For a longer sash, the connection member 310 can be mounted more proximate the end 154 of the connector 152, and for a shorter sash, the connection member 310 can be mounted more distal to the end 154. The use of the spacer member 317 described above facilitates this adjustable mounting. Excess length of the connector 152 can be cut or trimmed off, thus making the connector 152 effectively adjustable in length as well.

As described above, the sash lock mechanism 132 operates as described above, with the handle 136 being moveable between locked, unlocked, and tiltable positions. As the handle 136 moves from the unlocked to the tiltable position, the rotor 144 and pawl 172 rotate as well, and the pawl 172 is operably connected to one of the connectors 152 by the connection member 310 to effect movement of the connector 152. Movement of the one connector 152 causes rotation of the pinion gear 301, which in turn causes reciprocal movement of the other connector 152, by engagement between the teeth 301a of the pinion gear 301 and the teeth 152a of the connector. Accordingly, by moving the handle 136 from the unlocked to the tiltable position, both of the connectors 152 are moved to retract the latch bolts, as illustrated by the arrows in FIG. 45.

The sash lock mechanism 132 can also be designed to incorporate a forced entry resistance mechanism, such as the locking mechanism described in U.S. patent application Ser. No. 12/110,642, filed Apr. 28, 2008, which is incorporated herein by reference. FIGS. 57-62 illustrate one embodiment of this locking mechanism 400, which selectively prevents rotation of the cam 444 from the locked position. The locking mechanism 400 generally includes a moveable member or rocker 401 that is pivotably mounted on the housing 482 and operable to engage the cam 444 to selectively prevent rotation of the cam 444 from the locked position. In one exemplary embodiment, the moveable member 401 is made of zinc or another suitable metal, but in other embodiments, the moveable member 401 may be made from a different material, such as a polymer or composite. In the embodiment illustrated in FIGS. 57-62, the housing 482 has an internal mounting structure 496 for pivotably mounting the moveable member 401 and an opening 497 extending across a portion of the top and front of the housing 482, to allow access to the moveable member 401 through the housing 482. The mounting structure 496 includes a receiver 498 adapted to receive a portion of the moveable member 401 therein in a pivotable arrangement. In one exemplary embodiment, the receiver 498 is partially defined by two fingers 499 adapted to wrap around a portion of the moveable member 401 to connect the moveable member 401 to the receiver 498. As shown in FIGS. 57-62, the moveable member 401 includes an actuator portion 402, a mounting arm 403, and a leg 404 extending from the actuator portion 402, the leg 404 having an engagement surface 406 thereon for engaging the cam 444 to prevent rotation thereof.

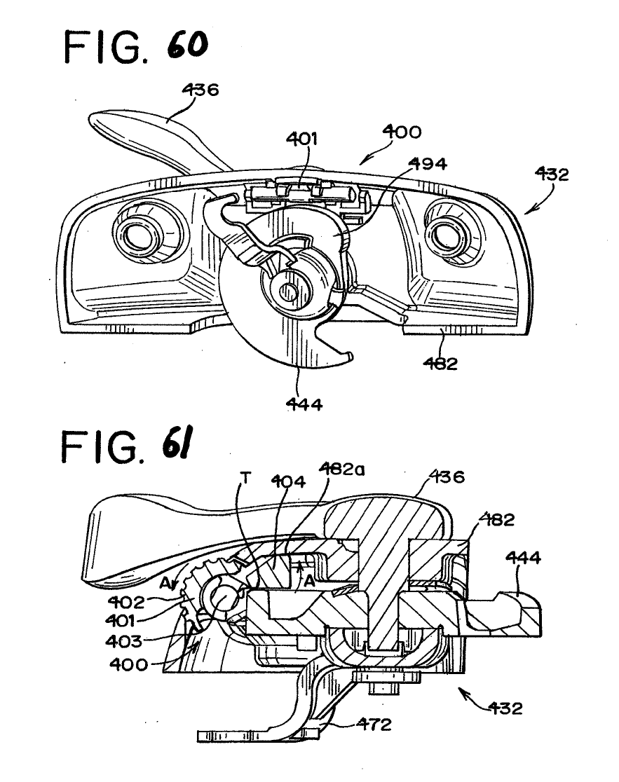

As illustrated in FIGS. 57-62, the moveable member 401 is moveable by pivoting or rotating between a first, or secure position and a second, or free position. In the secure position, shown in FIGS. 57-59, the moveable member 401 engages the cam 444 to prevent rotation of the cam 444 from the locked position. In the illustrated embodiment, when the cam 444 is in the locked position and the moveable member 401 is in the secure position, the engagement surface 406 confronts the cam portion 494. More specifically, in this embodiment, the engagement surface 406 confronts a side surface of the cam portion 494. When the cam 444 is rotated toward the unlocked position, the engagement surface 406 engages the cam portion 494, and this engagement prevents rotation of the cam 444 from the locked position. In the free position, shown in FIGS. 60-61, the moveable member 401 is pivoted (as indicated by arrows A) so that the leg 404 moves upward over the top surface (T) of the cam 444, between the cam 444 and the underside of the housing, and the engagement surface 406 no longer engages the cam 444, allowing the cam 444 to be rotated from the locked position to the unlocked position. In the embodiment shown, the actuator portion 402 rotates from the top to the bottom of the housing 482 to move the moveable member 401 from the secure position to the free position. FIGS. 60-61 show the cam 444 rotated part way between the locked position and the unlocked position, with the leg 404 of the moveable member 401 rotated to the free position. In the embodiment shown in FIGS. 60-61, the entire leg 404 is located above the top surface (T) of the cam 444, adjacent the ceiling 482a of the housing 482. The moveable member 401 pivots between the secure position and the free position on an axis of rotation 401a (FIG. 59) defined by the mounting arm 403. In the embodiment illustrated, the axis of rotation 401a of the moveable member 401 is substantially parallel to one or more adjacent surfaces of the housing 482, such as the top surface 483, as shown in FIGS. 59 and 61. In this embodiment, the axis of rotation 401a of the moveable member 401 is generally transverse to the axis of rotation 436a of the actuator 436 and cam 444. More specifically, in this embodiment, the axis of rotation 401a of the moveable member 401 is substantially perpendicular to the axis of rotation 436a of the actuator 436 and cam 444. Further, in this embodiment, the leg 404 extends in a direction generally transverse to the axis of rotation 401a of the moveable member 401.

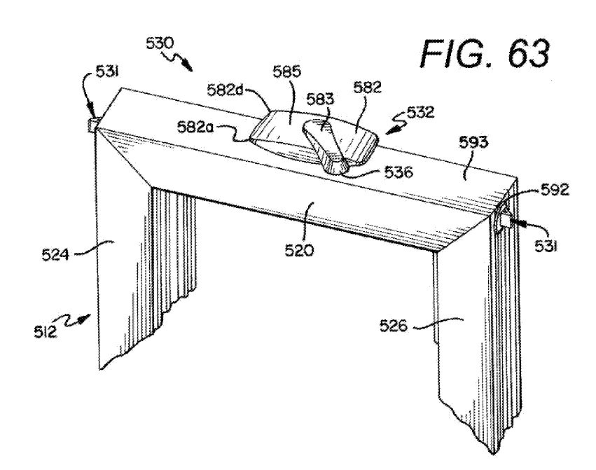

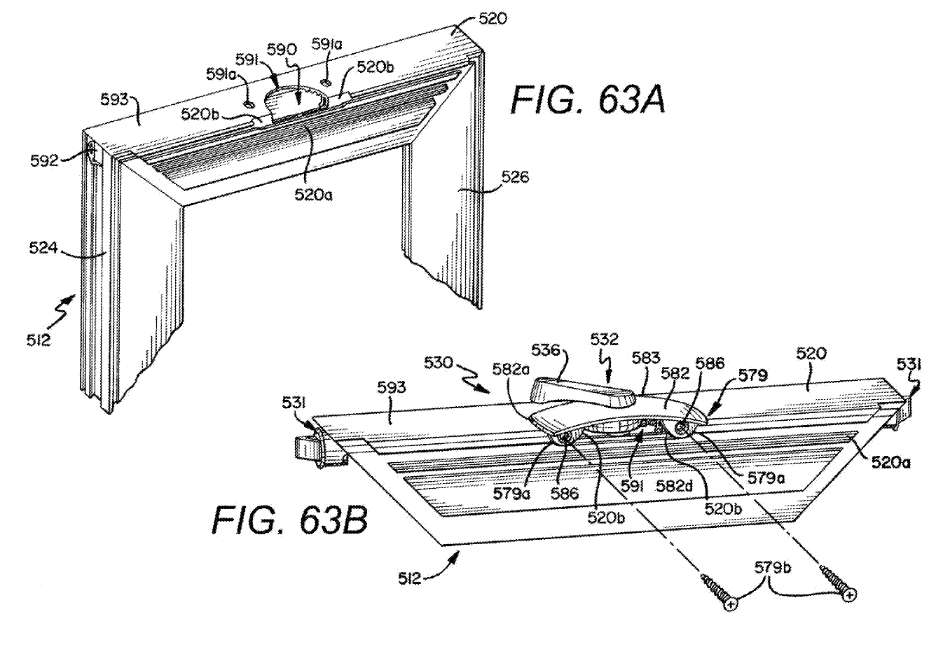

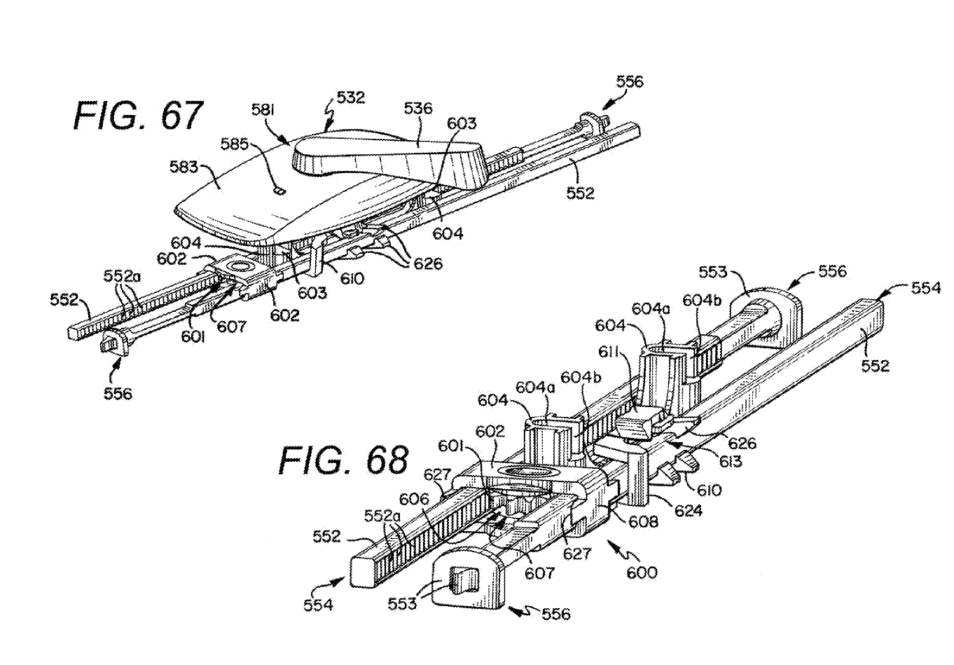

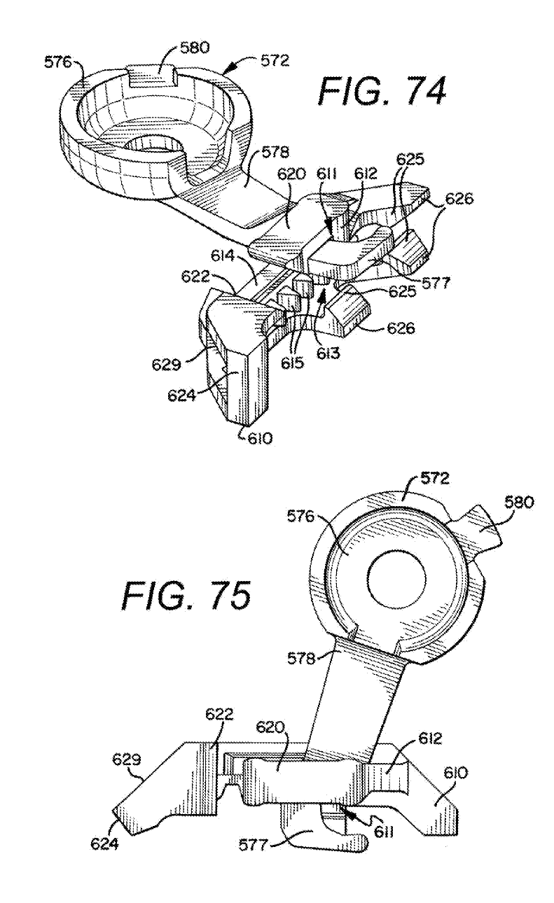

A further embodiment of an integrated tilt latch and sash lock assembly 530 is illustrated in FIGS. 63-78. Most of the components of the integrated assembly 530 shown in FIGS. 63-78 are the same or similar to those of the integrated tilt latch and sash lock assemblies 30, 130 described above and shown in FIGS. 1-38 and 40-56, and similar components are consistently numbered using the “500” series of reference numbers. Additional components of the integrated assembly 530 may be described using reference numerals 600-629. As illustrated, the integrated assembly 530 is adapted for use in a sash window 512 as shown in FIGS. 63-63B, and is adapted to be mounted on the top sash rail 520 of the sash window 512. The integrated assembly 530 includes a sash lock mechanism 532 that is operable to control two tilt latch mechanisms 531 through the use of a drive mechanism 600. It is understood that the integrated assembly 530 is able to be used with a single tilt latch mechanism 531, such that part or all of the drive mechanism 600 may not be necessary. The integrated tilt latch and sash lock assembly 530 is configured for mounting in a sash window 512 as shown in FIGS. 63-63B, such that the sash window 512 can be configured with an opening 591 in the top sash rail 520 for the sash lock mechanism 532 and two openings 592 in the stiles 524, 526 for the tilt latch mechanisms 531, to allow functioning of these respective components within the internal cavity 590 of the top sash rail 520. As shown in FIG. 63A, the opening 591 for the sash lock mechanism 532 exists in both the top surface 593 and the unexposed rear surface 520a of the top sash rail 520. Additionally, the top sash rail 520 includes two smaller peg apertures 591a in the top surface 593, on opposite sides of the sash lock opening 591, which receive pegs 603 extending from the underside of the sash lock housing 582, as described in greater detail below.

The sash lock mechanism 532 of the integrated assembly shown in FIGS. 63-78 is similar in structure to the sash lock mechanisms 32, 132 described above, and includes an actuator arm or handle 536 connected to a cam or rotor 544 which is operably connected to a pawl 572, and a housing 582 supporting the other components of the sash lock mechanism 532. The handle 536, rotor 544, and pawl 572 of the sash lock mechanism 532 are similar both structurally and functionally to the handle 36, 136, rotor 44, 144, and pawl 72, 172 described above. Additionally, the sash lock mechanism 532 operates similarly to the sash lock mechanisms 32, 132 described above. The housing 582, which is shown in FIGS. 63-67 and 73, is configured differently than the housing 82 described above, as the housing 582 has internal mounting structure configured for internal connection to the top sash rail 520 of the window 512, similar to the housing 182 described above and shown in FIGS. 40, 42-45, and 51. In contrast, the housing 82 described above has externally-visible mounting structure configured for mounting to the top sash rail 20 by connection to the top surface of the sash rail 20. It is understood, in view of the description below, that certain other differences exist between the housing 582 and the housing 182 described above and shown in FIGS. 40, 42-45, and 51.

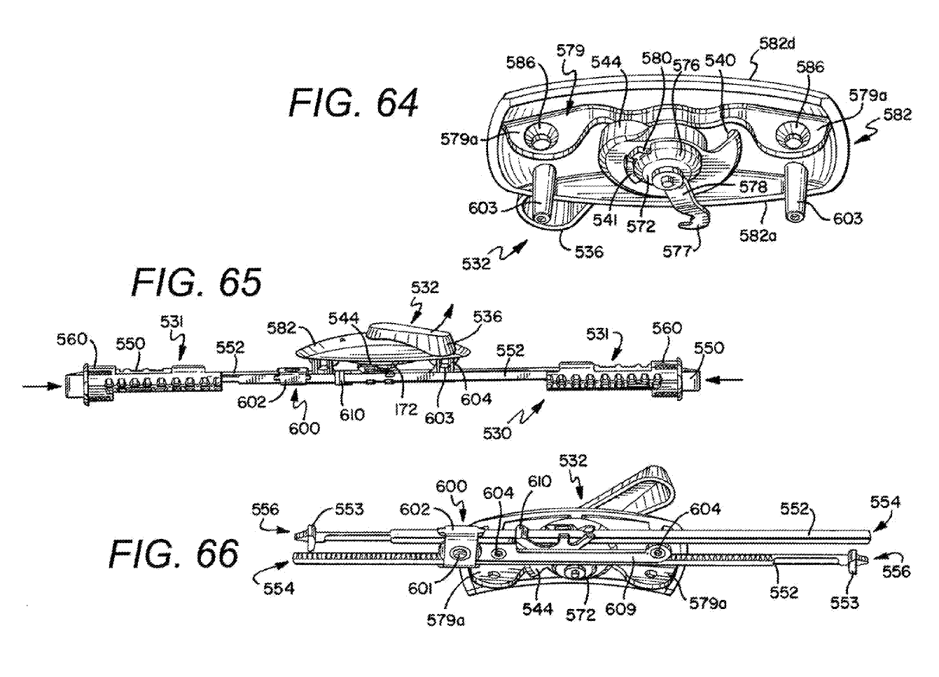

The housing 582 is adapted to be mounted on the top sash rail 520 to mount the sash lock mechanism 532 to the sash window assembly 10. In one exemplary embodiment, the housing 582 is made of cast metal. The housing 582 has an opening 581 therein and indicia 585 on the top surface 583 thereof to indicate the position of the handle 536. As seen in FIGS. 63-66, the housing 582 has an internal mounting structure 579 for mounting to the top sash rail 520 by connection to a non-exposed surface (such as a side surface or an internal surface) of the sash rail 520. In the embodiment illustrated, the internal mounting structure 579 includes a pair of flanges 579a connected to an internal surface on the underside of the housing 582 and depending from the housing 582. Each flange 579a has a screw aperture 586 for insertion of fasteners 579b to connect the housing 582 to the top sash rail 520, as shown in FIGS. 63B-64. The flanges 579a are positioned to allow connection of the fasteners 579b to the unexposed rear surface 520a of the top sash rail 520. Additionally, the flanges 579a are positioned inwardly of the outer edges 582a of the housing 582 that sit upon the top surface 593 of the top rail 520 of the sash window 512, and extend below the outer edges 582a. As seen in FIGS. 63A-B, the rear surface 520a of the sash rail 520 includes a recess 520b that receives the flanges 179a so that the flanges 179a do not protrude from the rear surface 520a and do not interfere with opening and closing the window 512. Connection to the unexposed rear surface 520a of the sash rail 520 allows for concealing the fasteners 579b, which provides an aesthetically pleasing appearance, since no mounting structure is externally visible. The housing 582 further includes an overhanging portion 582d that extends rearwardly from the flanges 579a and past the rear surface 520a of the sash rail 520 when mounted, as shown in FIGS. 63B-64. In this embodiment, the overhanging portion 582d is formed by an arched rear edge of the housing 582. This overhanging portion 582d provides additional concealment of the mounting structure (which may include concealment of the keeper 42) and a pleasing aesthetic appearance.

In other embodiments, the housing 582 may include a different internal mounting structure, and may be configured for connection to an internal surface of the sash rail 520 to provide non-exposed mounting. The housing 582 further has additional features similar to those described above with respect to the integrated assembly 30 illustrated in FIGS. 2-38 and the integrated assembly 130 illustrated in FIGS. 40-56. It is understood that various features of the integrated assembly 530, such as the drive mechanism 600 described below, can be incorporated for use with a sash lock housing that has similar mounting structure to the housing 82 described above in connection with the embodiment of FIGS. 2-39. The sash lock mechanism 532 can also be designed to incorporate a forced entry resistance mechanism, such as the locking mechanism 400 described above and illustrated in FIGS. 57-62.

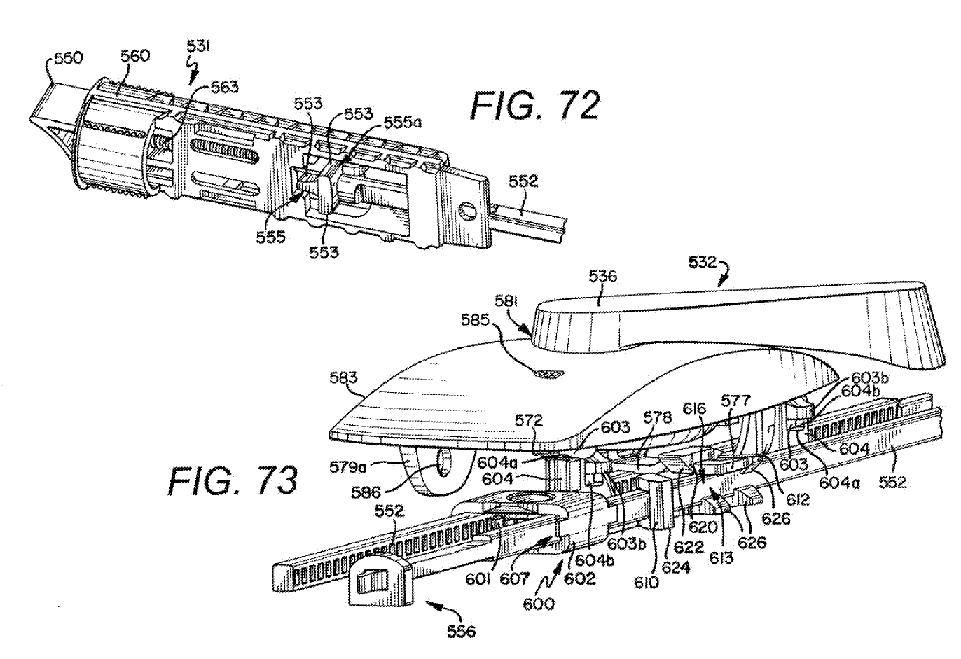

The tilt latch mechanisms 531 of the integrated assembly 530 shown in FIGS. 63-78 are generally similar to the tilt latch mechanisms 31, 131 of the integrated assemblies 30, 130 described above and shown in FIGS. 2-38 and 40-56. The tilt latch mechanisms 531 illustrated in FIGS. 63, 65, and 72 generally include a latch bolt 550 disposed within a tilt latch housing 560 and a means 563 for biasing the latch bolt outwardly, as described above. Additionally, the latch bolts 550 and connectors 552 are adapted for a snap-fit connection 555, similarly to the snap fit connections 55, 155 between latch bolts 50, 150 and the connectors 52, 152 described above, as seen in FIG. 72.

An example of a connector 552 of the integrated assembly 530 is shown in greater detail in FIGS. 71 and 72. One end 556 of the connector 552 is adapted for snap-fit connection to the latch bolt 550, by fitting into a recess 555a on the latch bolt, and the connector 552 has resilient bracing arms 553 for bracing the snap-fit connection 555. Additionally, as described above, the connector 552 has a plurality of teeth 552a, which can engage teeth 601a of a pinion 601 to be further described. The connector 552 shown in FIGS. 71 and 72 has teeth 552a on only one side thereof, in contrast to the connector 152 illustrated in FIGS. 49-51, which has teeth 152a on two opposed sides. Further, unlike the connector 52 described above, the illustrated embodiment of the connector 552 does not have a hitch or other such connection for engaging the pawl 572. Rather, a connection member 610 is provided to operably connect the pawl 572 to the connector 552 in this embodiment, as described in greater detail below, and similarly to the connector 152 and connection member 310 described above. It is understood that the connector 552 can be configured for direct connection to the pawl 572 in other embodiments, such as by using the hitch structure 59 described above.

The integrated assembly 530 shown in FIGS. 63-78 includes the drive assembly 600, which enables the single sash lock mechanism 532 to operate the two tilt latch mechanisms 531. In the embodiment illustrated in FIGS. 65-70 and 73, the drive assembly 600 has a rack-and-pinion configuration, which generally includes a rotatable pinion gear 601 that engages the two connectors 552, with each of the connectors 552 having a plurality of teeth 552a for engaging the pinion gear 601. Through the rack-and-pinion configuration, movement of one connector 552 causes simultaneous movement of the other connector 552, allowing operation of both connectors 552 by the sash lock mechanism 532. Accordingly, the connector 552 that is connected to the pawl 572 or otherwise operably connected to the sash lock mechanism 532 may be referred to as the “drive” or “active” connector 552, and the other connector 552 may be referred to as the “passive” connector.

One illustrative embodiment of the pinion gear 601 is shown in more detail in FIGS. 68-70, 73, and 78 and is mounted within a pinion housing 602. The pinion housing 602 is connected to the sash lock housing 582, and the pinion gear 601 is free to rotate within the pinion housing 602. As shown in FIGS. 64, 66, 68, 29, 73, and 78, the pinion gear 601 is mounted within an internal cavity 606 in the pinion housing 602, as described in greater detail below. The pinion housing 602 is mounted on pegs 603 depending from the inner surface or underside of the sash lock housing 582. As described above, the pegs 603 are inserted through peg apertures 591a in the top sash rail 520. In this embodiment, the pinion housing 602 has an elongated mounting body 609 connected thereto. The mounting body 609 includes two receivers 604 that are each configured to receive one of the pegs 603 to fixedly connect the housing 602 to the pegs 603. In this embodiment, the receivers 604 are each formed as a post extending upward from the mounting body 609, having a passage 604a extending therethrough to receive the respective peg 603. The passages 604a of the receivers 604 extend through the pinion housing 602 to enable insertion the pegs 603 to retain the pinion housing 602 to the sash lock housing 582. Additionally, the receivers 604 each have a side slot 604b, and the pegs 603 each have a projection 603b that is received in the respective slot 604b. The projections 603b and slots 604b create a locking arrangement to further secure the pinion housing 602, and also to ensure that the pinion housing 602 is mounted to the sash lock housing 582 in the proper configuration and orientation. The projections 603b also engage the inner surface of the top sash rail 520, so that both the top surface 593 and the inner surface (not shown) of the top sash rail 520 are engaged by the sash lock housing 582, to create a more secure mounting connection. More specifically, at least the outer edge 582a of the housing 582 engages the top surface 593 of the top sash rail 520 and the projections 603b engage the inner surface. The pegs 603 and/or the pinion housing 602 may contain additional retaining structure to secure the connection therebetween in some embodiments, including screws or other fasteners, or an adhesive. In another embodiment, the pegs 603 may have passages extending completely through to the top surface of the sash lock housing 582, which can permit fasteners to be inserted through the passages both to mount the sash lock mechanism 532 to the sash window 512 and to connect the pinion housing 602 to the sash lock housing 582. This embodiment may be used, for example, with a sash lock mechanism similar to the mechanism 32 described above and shown in FIGS. 2-39, which receives fasteners through the top surface 83 of the housing 82 to mount the sash lock mechanism 32 to the top sash rail 20. In further embodiments, the pinion housing 602 may be mounted to the sash lock housing 582 in another manner, or may not be connected to the sash lock housing 582.

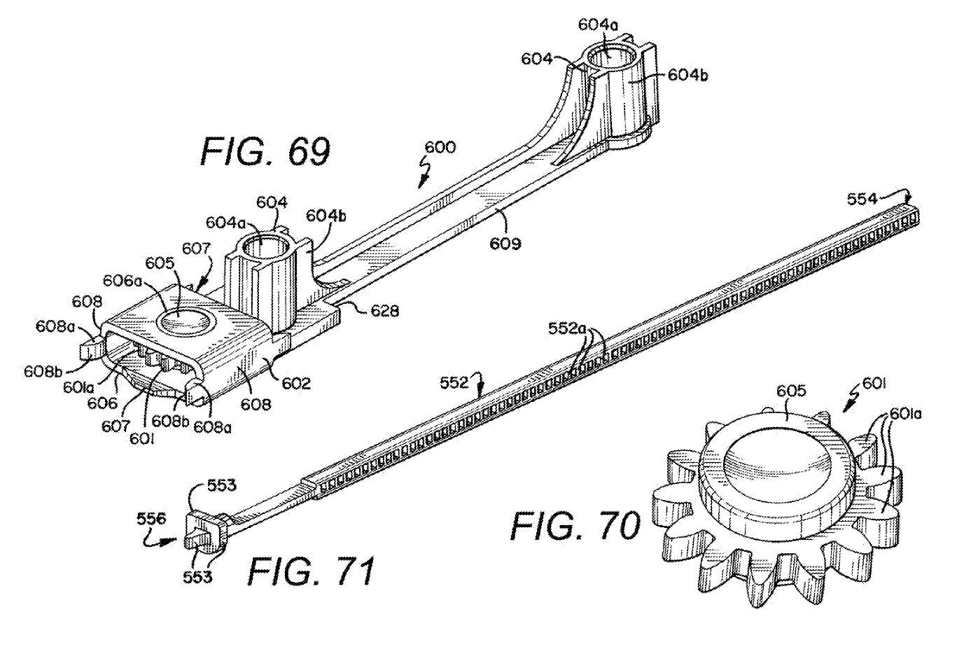

The pinion housing 602 has an internal cavity 606 that receives the pinion gear 601 such that the pinion gear 601 can freely rotate within the pinion housing 602, as shown in FIGS. 68-69. The pinion gear 601 has axles 605 that fit within apertures 606a in the pinion housing 602, such that the pinion gear 601 can freely rotate about the axles 605, providing a rotational axis for the pinion gear 601. The pinion gear 601 has a plurality of gear teeth 601a that engage the teeth 552a on the connectors 552, so that rotation of the pinion gear 601 operates to transfer movement between the connectors 552.

The pinion housing 602 also has opposed side openings 607 and opposed side walls 608, as illustrated in FIGS. 68-69. The side openings 607 to permit the connectors 552 to extend through the housing cavity 606 and engage the pinion gear 601, and the side walls 608 hold the connectors 552 in position to ensure that the teeth 552a of the connectors 552 remain in engagement with the teeth 601a of the pinion gear 601. The side walls 608 further include guides 608a with contoured surfaces 608b to further guide and assist the movement of the connectors 552 through the pinion housing 602.

As shown in FIG. 73, the pinion gear 601 and pinion housing 602 have a low-profile configuration, such that the pinion gear 601 and pinion housing 602 do not extend appreciably lower than other lowermost components of the sash lock mechanism 532, such as the pawl 572. This permits the sash lock mechanism 532 and the drive assembly 600 to fit within the internal cavity 190 of the top sash rail 520 without necessitating any change in the dimensions or internal configuration of the top sash rail 520. It is understood that the pinion housing 602 may be a single unitary structure or multiple components connected together.

As illustrated in FIGS. 65-68 and 73-78, the pawl 572 is operably connected to the connector 552, and the rotor 544 is likewise operably connected to the connector 552 via the pawl 572. In one embodiment, a connection member 610 can be used to form an operable connection between the pawl 572 of the sash lock mechanism 532 and the connector 552, to allow the pawl 572 to move the connector 552. In the embodiment shown in FIGS. 65-68 and 73-78, the connection member 610 is adapted for connection to the appending member 578 of the pawl 572 and is also adapted for connection to the connector 552 by engaging the teeth 552a of the connector 552. In the illustrated embodiment, the connection member 610 has a receiver 611 therein to receive the hook 577 on the appending member 578 of the pawl 572. Additionally, the hook 577 engages a wall 612 adjacent the receiver 611 to exert force on the connection member 610. In this embodiment, the receiver 611 is defined by a flexible locking tab 620 that flexes to allow the appending member 578 to be inserted into the receiver 611 and retains the appending member 578 within the receiver 611 after insertion. The connecting member 610 also has a ramped surface 622 extending toward the flexible tab 620 to guide and assist insertion of the appending member 578 into the receiver 611. It is understood that the connection member 610 may be designed differently for connection to the pawl 572, such as if the pawl 572 has a different type of connecting structure other than the hook 577. Further, as shown in FIG. 65, the connecting member 610 is connected to the connector 552 on the opposite side of the pinion gear 601 as the end 556 of the connector and the tilt latch mechanism 531 to which the connector 552 is connected.

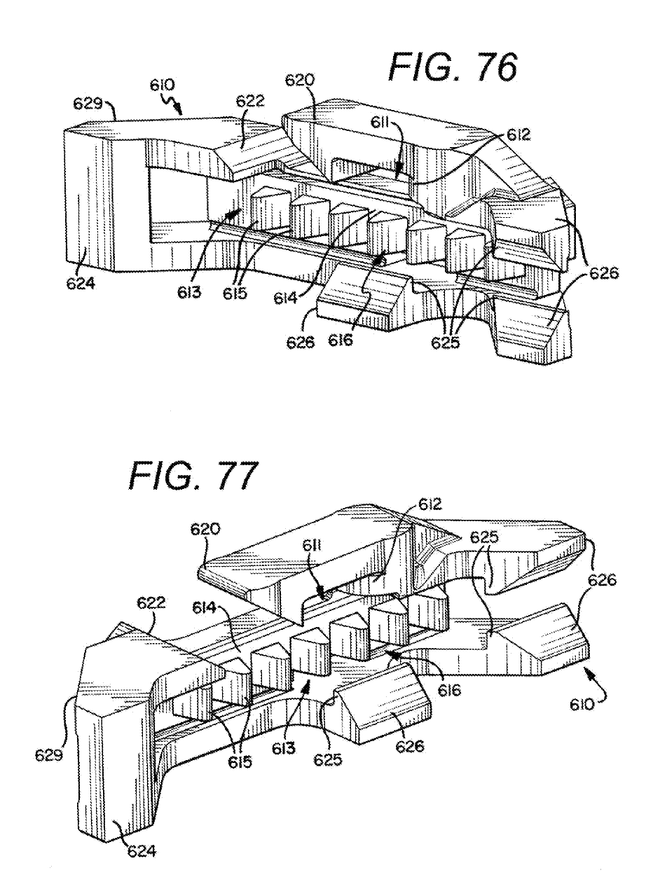

The illustrated embodiment of the connection member 610 also has an internal passage 613 for receiving a portion of the connector 552 therethrough, to connect the connector 552 to the connection member 610. The connection member 610 further has a side wall 614, a bracing member 624, and flexible arms 626 defining the passage 613. The side wall 614 has teeth 615 thereon for engaging the teeth 552a of the connector 552 to connect the connection member 610 to the connector 552. The teeth 615 of the connection member 610 and the teeth 552a of the connector 552 interlock to form a secure connection. In this embodiment, the connection member 610 is made of a resilient material, and has a gap 616 between the flexible arms 626 to allow for insertion of the connector 552 into the passage 613. The flexible arms 626 are able to flex outward to permit the connector 552 to be inserted into the passage 613, and each flexible arm 626 includes a locking tab 625 that engages the connector 552 to retain the connector within the passage 613 after insertion. The flexible arms 626 can also be pulled apart to release the connector 552 from the passage 613. In this embodiment, the connection member 610 includes three flexible arms 626, and at least two of the flexible arms are positioned in opposed relation to each other, on opposite sides of the passage, to engage the connector 552 in the clamping configuration. As seen in FIGS. 76-77, the connection member 610 has two flexible arms 626 on the bottom side and a single flexible arm 626 on the top side. It is understood that the connector may be partially inserted in the passage by inserting the connector through the bracing member 624, which allows the connecting member 610 to slide along the connector 552 to a desired position, at which point the connector 552 can be pivoted to slip through the gap 616 and fully into the passage 613. In another embodiment, the teeth 552a of the connector 552 and/or the teeth 615 of the connection member 610 may be angled to create more secure interlocking between the teeth 552a, 615, and the teeth 552a, 615 may be angled in opposite directions. It is understood that the connection member 610 can be used in an integrated tilt latch and sash lock assembly in which only a single tilt latch mechanism is used, such as the integrated assembly 30 illustrated in FIGS. 1-39.

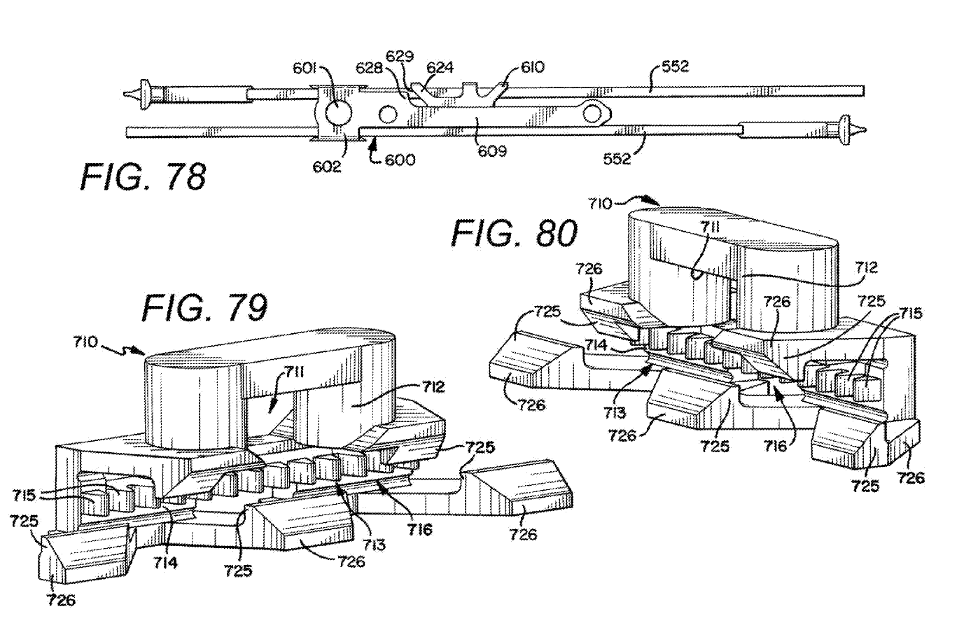

In the embodiment illustrated in FIGS. 66 and 78, the pinion housing 602 and the connection member 610 have registration means or features 628, 629 to facilitate proper positioning of the connection member 610 relative to the pinion housing 602 and sash lock mechanism 532 during installation. The pinion housing 602 has a stop surface 628 defined on the mounting body 609, and the connection member 610 has a confronting surface 629 defined on the bracing member 624. The stop surface 628 and the confronting surface 629 are configured to confront and/or engage each other when the connection member 610 is approximately in the position where the connection member 610 should be when the integrated assembly 530 is in the locked and/or unlocked position, in order to facilitate mounting of the connection member 610 and connecting the connection member 610 to the pawl 572. Accordingly, when a person is connecting the connection member 610 to the connector 552, the connection member 610 can be adjusted until the confronting surface 629 confronts the stop surface 628 on the pinion housing 602, thus ensuring that the pawl 572 and the connection member 610 will be in proper configuration and alignment for operation of the integrated assembly 530. As a result, little to no measurement, trial-and-error adjustment, or calibration is necessary on the part of a person installing the integrated assembly 530. Such installation is described in greater detail below. It is understood that the integrated assembly 530 may allow room for error, such that the necessary distance between the confronting surface 629 and the stop surface 628 of the pinion housing 602 may have a certain error tolerance. It is further understood that the connection member 610 and/or the pinion housing 602 may be modified for connecting to a different embodiment of the sash lock mechanism 532. In another embodiment, the connection member 610 may have a different type of registration means, such as a spacer member 317 as described above, or which may use a different component for reference other than the pinion housing 602.

The connector 552 may also have registration means or features, to facilitate proper positioning of the connector 552 relative to the pinion housing 602 during installation. In one embodiment, the connectors 552 each have indicia 627 thereon that marks the proper positions of the connectors 552 relative to the pinion housing when the integrated assembly 530 is in the locked and/or unlocked position, as shown in FIG. 68. In another embodiment, the connectors 552 may be configured for sequential insertion into the drive mechanism 600, and at least the first-inserted connector 552 may have indicia 627 that marks the position of that connector when the second connector 552 should be inserted into the pinion housing 602, so that the action of the pinion gear 601 will bring both connectors 552 simultaneously into proper position. In a further embodiment, one or both of the connectors 552 may have a plurality of different indicia or other registration means to indicate proper positioning of the connectors 552 for mounting in a plurality of different windows 512 of different sizes, including having different sash lengths. In other embodiments, the connector 552 may have a different type of registration means, which may use a different component for reference other than the pinion housing 602.

The connection member 610 is adjustable, and can be connected to the connector 552 in a number of different positions, as described above. Because the connector 552 and the connection member 610 in this embodiment are adjustable, and the connector 552 has no fixed structure for connection to the pawl 572 (such as the hitch 59 described above), a single connector length can be used for mounting the integrated assembly 530 in a variety of sash rails having different lengths. For a longer sash, the connection member 610 can be mounted more proximate to the distal end 554 of the connector 552, and for a shorter sash, the connection member 610 can be mounted more distal from the distal end 554. The use of the registration features described above facilitates this adjustable mounting. Excess length of the connector 552 can be cut or trimmed off, thus making the connector 552 effectively adjustable in length as well. It is noted that the connectors 552 as illustrated in FIGS. 66-68 are straight, and are parallel and offset from each other. However, the tilt latch mechanisms 531 are typically not offset from each other, and are located along the same line. Accordingly, the connectors 552 illustrated in FIGS. 66-68 are flexible and resilient, and can be easily bent to connect to tilt latch mechanisms 531 that are not offset from each other, such as shown in FIGS. 63 and 65. In another embodiment, the connectors 552 may have permanent offset portions for this purpose, such as if the connectors 552 are made from a material with less flexibility, or may be positioned at oblique angles to one another.

FIGS. 79-80 illustrate an alternate embodiment of a connection member 710 that is suitable for use with the integrated assembly 530 in FIGS. 40-78. In this embodiment, the connection member 710 includes a receiver 711 that is similar to the receiver 311 in FIGS. 52-55, having a curved wall 712 for engagement by the appending member 578 of the pawl 572. The connection member 710 also includes an internal passage 713 defined by a side wall 714 and flexible arms 726 with locking tabs 725. The side wall 714 has teeth 715 thereon for engaging the teeth 552a of the connector 552 to connect the connection member 710 to the connector 552. Additionally, in this embodiment, the connection member 710 is made of a resilient material, and has a gap 716 between the flexible arms 726 to allow for insertion of the connector 552 into the passage 713. The connection member 710 includes five flexible arms 726 that are positioned in opposed relation to each other, with two arms 726 on the top side of the connection member 710 and three arms 726 on the bottom side.

The sash lock mechanism 532 operates as described above, with the handle 536 and the rotor 544 being moveable together between locked, unlocked, and tiltable positions. As the handle 536 moves from the unlocked to the tiltable position, the rotor 544 and pawl 572 rotate as well, due to abutting engagement between the abutment member 541 of the cam 544 and the tab 580 of the pawl 572. The pawl 572 is operably connected to one of the connectors 552 by the connection member 610, which, in turn, effects movement of the connector 552. Movement of the first connector 552 causes rotation of the pinion gear 601, which in turn causes reciprocal movement of the other connector 552, by engagement between the teeth 601a of the pinion gear 601 and the teeth 552a of the connectors 552. Accordingly, by moving the handle 536 from the unlocked to the tiltable position, both of the connectors 552 are moved to retract the latch bolts 550 to the retracted positions, as illustrated by the arrows in FIG. 65. When the handle 536 and the rotor 544 are returned to the unlocked and/or locked positions, the biasing means 563 of the tilt latch mechanisms 531 return the latch bolts 550 to the extended positions.

The features of the integrated tilt latch and sash lock assembly 530 can assist in achieving quick and easy installation in a sash window 512. To begin installation of the integrated assembly 530, once the sash lock mechanism 532, the tilt latch mechanisms 531, and the drive assembly 600 are assembled, the positions of the connectors are determined. This can be done using indicia 627 as described above, or by manual measurements, including by connecting the tilt latch mechanisms 531 to the connectors 552 and placing them on the top sash rail 520 to estimate the proper positions. The connectors 552 are then inserted through the pinion housing 602 and engaged with the pinion gear 601 in the proper positions. The connection member 610 is loosely slipped onto the end of the proper drive connector 552 by insertion through the bracing member 624, as described above, and the first (drive) connector 552 is connected to the tilt latch mechanism 531, if not connected already. At this point, the second (passive) connector 552 is not connected to the second tilt latch mechanism 531, so that the drive mechanism 600, both connectors 552, and the connection member 610 (which is loosely inserted on the drive connector 552) are inserted into the tilt latch opening 592 for the connected tilt latch mechanism 531, and the first tilt latch mechanism 531 follows the components into the opening 592 to mount the tilt latch mechanism 531. The passive connector 552 is then extended to the opposite tilt latch opening 592 and connected to the second tilt latch mechanism 531, and the second tilt latch mechanism 531 is mounted by insertion into the opening 592. Once the tilt latch mechanisms 531 are in place, the connection member 610 can be slid down the connector 552 until the confronting surface 629 confronts the stop surface 628 of the pinion housing 602, and then the connection member 610 is snapped into place by inserting the connector 552 through the gap 616 between the flexible arms 626, so that the teeth 615, 552a engage each other. After the connection member 610 is in place, the sash lock mechanism 532 is placed in position, so that the rotor 544 and the pawl 572 are received in the sash lock opening 591 and the pegs 603 are received in the peg apertures 591a. The pegs also extend into the receivers 604 in the pinion housing 602, which may require further movement of the pinion housing 602 to the proper position. The pawl 572 is then rotated, such as by rotation of the handle 536 to the tiltable position, to slip the hook 577 of the appending member 578 into the receiver 611 of the connection member 610, assisted by the flexible locking tab 620 and the ramped surface 622. Finally, the sash lock housing 582 is fastened to the top sash rail 520, completing the mounting of the integrated assembly 530. It is understood that the above description relates only to one possible method of mounting and installing the integrated assembly 530, and other suitable methods of mounting and installation are recognizable to those skilled in the art.

The various embodiments of the integrated tilt latch and sash lock assembly 130, 530 described herein provide benefits and advantages over prior such assemblies. For example, the drive mechanism 300, 600 permits effective operation of both tilt latches 131, 531 of the integrated assembly 130, 530 by the use of a single sash lock mechanism 132, 532. Additionally, the flexible, length-adjustable connectors 152, 552 and the adjustable connection member 310, 610, 710 permit installation of the integrated assembly 300, 600 in a wide variety of different sash windows having sashes over a wide range of lengths. Further, the internal mounting structure 179, 579 of the sash lock housing 182, 582 allows the sash lock mechanism 132, 532 to be mounted with an aesthetically pleasing appearance, as the mounting structure 179, 579 is concealed from external view, and the top surface of the housing 182, 582 is smooth and uninterrupted. Still other benefits and advantages are readily recognizable to those skilled in the art.

Several alternative embodiments and examples have been described and illustrated herein. A person of ordinary skill in the art would appreciate the features of the individual embodiments, and the possible combinations and variations of the components. A person of ordinary skill in the art would further appreciate that any of the embodiments could be provided in any combination with the other embodiments disclosed herein. It is further understood that the invention may be in other specific forms without departing from the spirit or central characteristics thereof. The present examples therefore are to be considered in all respects as illustrative and not restrictive, and the invention is not to be limited to the details given herein. The term “plurality,” as used herein, indicates any number greater than one, either disjunctively or conjunctively, as necessary, up to an infinite number. Accordingly, while the specific examples have been illustrated and described, numerous modifications come to mind without significantly departing from the spirit of the invention and the scope of protection is only limited by the scope of the accompanying claims.

What is claimed is:

1. An integrated sash lock and tilt-latch assembly for a sash window assembly, the sash window assembly having a lower sash window having a top rail, a bottom rail, and a pair of stiles and an upper sash window having a keeper, the integrated assembly comprising:
a sash lock mechanism adapted to be supported by the top rail, comprising a handle and a rotor coupled to the handle and being rotatable by movement of the handle;
a first tilt-latch mechanism adapted to be supported by the lower sash window and comprising a latch bolt slidably supported by the lower sash window and moveable between an extended position and a retracted position;
a second tilt-latch mechanism adapted to be supported by the lower sash window and comprising a latch bolt slidably supported by the lower sash window and moveable between an extended position and a retracted position;
a first connector operably connected to the rotor and having an end operably connected to the latch bolt of the first tilt-latch mechanism;
a second connector having an end operably connected to the latch bolt of the second tilt-latch mechanism; and
a drive mechanism operably connecting the first connector and the second connector such that movement of the first connector activates the drive mechanism, and activation of the drive mechanism creates reciprocal movement of the second connector,
wherein the rotor is moveable among a locked position, an unlocked position and a tiltable position, wherein the rotor is adapted to engage the keeper in the locked position, wherein the rotor is adapted to be disengaged from the keeper in the unlocked position, and wherein when the rotor is moved to the tiltable position, the first connector moves the latch bolt of the first tilt-latch mechanism to the retracted position and the drive mechanism moves the second connector to move the latch bolt of the second tilt-latch mechanism to the retracted position.

2. The integrated sash lock and tilt-latch assembly of claim 1, wherein the drive mechanism and the connectors are arranged in a rack and pinion configuration.

3. The integrated sash lock and tilt-latch assembly of claim 1, wherein the drive mechanism comprises a rotatable pinion gear engaging the first connector and the second connector, wherein movement of the first connector causes rotation of the pinion gear, and rotation of the pinion gear causes the reciprocal movement of the second connector.

4. The integrated sash lock and tilt-latch assembly of claim 3, wherein the first connector has a plurality of teeth disposed along at least a portion of the first connector, the second connector has a plurality of teeth disposed along at least a portion of the second connector, and the pinion gear has a plurality of gear teeth engaging the teeth of the first and second connectors.

5. The integrated sash lock and tilt-latch assembly of claim 3, wherein the drive mechanism further comprises a pinion housing, wherein the pinion gear is rotatably disposed within the pinion housing.

6. The integrated sash lock and tilt-latch assembly of claim 5, wherein the sash lock mechanism further comprises a sash lock housing adapted to be mounted to the top rail of the lower sash window, and wherein the pinion housing is mounted to an underside of the sash lock housing.

7. The integrated sash lock and tilt-latch assembly of claim 1, wherein the sash lock mechanism further comprises a pawl operably connected to the rotor, wherein the rotor and the pawl rotate together over a portion of a range of rotation of the rotor, and wherein the pawl comprises a base and an appending member extending from the base, the appending member operably connected to the first connector.

8. The integrated sash lock and tilt-latch assembly of claim 7, further comprising a connection member connecting the pawl to the connector.

9. The integrated sash lock and tilt-latch assembly of claim 8, wherein the drive mechanism further comprises a pinion gear rotatably disposed within a pinion housing, the pinion gear engaging the first and second connectors, wherein the pinion housing has a stop surface, and the connection member has a confronting surface configured to confront the stop surface when the rotor is in the locked position.

10. The integrated sash lock and tilt-latch assembly of claim 7, wherein the pawl is operably connected to the first connector on an opposite side of the pinion gear as the end of the first connector that is operably connected to the latch bolt of the first tilt-latch mechanism.

11. A sash lock mechanism for a sash window assembly, the sash window assembly having a lower sash window having a top rail, a bottom rail, and a pair of stiles, and an upper sash window having a keeper, the sash lock mechanism comprising:
a handle;
a housing adapted to be supported on a top surface of the top rail, the housing having an opening receiving the handle therethrough and a concealed mounting structure adapted to be connected to a concealed surface of the top rail to mount the sash lock mechanism on the sash rail; and
a rotor coupled to the handle and rotatably mounted on an underside of the housing, the rotor being moveable between at least a locked position and an unlocked position by movement of the handle.

12. The sash lock mechanism of claim 11, wherein the concealed mounting structure comprises a flange depending from an inner surface of the housing and adapted to engage an unexposed rear surface of the top rail.

13. The sash lock mechanism of claim 12, wherein the flange has an aperture configured to receive a fastener therein to connect the flange to the unexposed rear surface of the top rail.

14. The sash lock mechanism of claim 11, wherein the concealed mounting structure comprises a pair of flanges depending from an inner surface of the housing, each of the pair of flanges adapted to engage an unexposed rear surface of the top rail.

15. The sash lock mechanism of claim 11, wherein the housing has an outer edge configured to sit upon the top surface of the top rail and a rear edge arched above the top surface of the top rail, and the concealed mounting structure comprises a flange depending from an inner surface of the housing, the flange being spaced inwardly from the rear edge and adapted to engage an unexposed rear surface of the top rail.

16. The sash lock mechanism of claim 15, wherein the flange has an aperture configured to receive a fastener therein to connect the flange to the unexposed rear surface of the top rail.

17. The sash lock mechanism of claim 11, wherein the housing has an outer edge configured to sit upon the top surface of the top rail and a rear edge arched above the top surface of the top rail, and the concealed mounting structure comprises a pair of flanges depending from an inner surface of the housing, each of the pair of flanges being spaced inwardly from the rear edge and adapted to engage an unexposed rear surface of the top rail.

18. A sash window comprising:
a top rail, a bottom rail, and a pair of stiles connecting the top rail and the bottom rail, the top rail having a top surface and a rear surface and a sash lock opening located in the top surface and the rear surface, wherein the rear surface is adapted to be unexposed when the sash window is mounted in a window frame as part of a sash window assembly; and
a sash lock mechanism mounted on the top rail, wherein the sash lock mechanism comprises:
a handle;
a housing supported on the top surface of the top rail, the housing having an opening receiving the handle therethrough and a concealed mounting structure connected to the rear surface of the top rail to mount the sash lock mechanism on the sash rail, such that the housing covers at least a portion of the sash lock opening; and
a rotor coupled to the handle and rotatably mounted on an underside of the housing, such that the rotor is positioned at least partially within the sash lock opening, the rotor being moveable between at least a locked position and an unlocked position by movement of the handle.

19. The sash window of claim 18, wherein the concealed mounting structure comprises a flange depending from an inner surface of the housing, the flange engaging the rear surface of the top rail adjacent the sash lock opening.

20. The sash window of claim 19, wherein the rear surface of the top rail has a recess therein adjacent the sash lock opening, wherein the flange is received in the recess when the housing is mounted on the top rail.

21. The sash window of claim 18, wherein the concealed mounting structure comprises a pair of flanges depending from an inner surface of the housing, each of the flanges engaging the rear surface of the top rail on opposite adjacent sides of the sash lock opening.

22. The sash window of claim 19, wherein the rear surface of the top rail has a pair of recesses therein on the opposite adjacent sides of the sash lock opening, wherein the flanges are each received in one of the recesses when the housing is mounted on the top rail.

23. The sash window of claim 18, wherein the flange has an aperture configured to receive a fastener therein to connect the flange to the unexposed rear surface of the top rail.

24. An integrated sash lock and tilt-latch assembly for a sash window assembly, the sash window assembly having a lower sash window having a top rail, a bottom rail, and a pair of stiles and an upper sash window having a keeper, the integrated assembly comprising:
a sash lock mechanism adapted to be supported by the top rail, comprising:
a handle;
a housing adapted to be supported on a top surface of the top rail, the housing having an opening receiving the handle therethrough;
a rotor coupled to the handle and being moveable by movement of the handle; and
a pawl operably connected to the rotor, wherein the rotor and the pawl rotate together over a portion of a range of rotation of the rotor;
a tilt-latch mechanism adapted to be supported by the lower sash window and comprising a latch bolt slidably supported by the lower sash window and moveable between an extended position and a retracted position;
a connector having an end operably connected to the latch bolt of the tilt-latch mechanism; and
a connection member connecting the pawl to the connector, the connection member having a passage receiving a portion of the connector therethrough,
wherein the rotor is moveable among a locked position, an unlocked position and a tiltable position, wherein the rotor is adapted to engage the keeper in the locked position, wherein the rotor is adapted to be disengaged from the keeper in the unlocked position, and wherein the latch bolt is moved to the retracted position in the tiltable position.

25. The integrated sash lock and tilt-latch assembly of claim 24, wherein the connection member has a plurality of teeth within the passage, and the connector has a plurality of complementary teeth that engage the teeth of the connection member to retain the connection member to the connector.

26. The integrated sash lock and tilt-latch assembly of claim 24, wherein the pawl has an appending member, and the connection member has a receiver to receive a portion of the appending member.

27. The integrated sash lock and tilt-latch assembly of claim 26, wherein the receiver of the connecting member has a flexible tab that flexes to allow the appending member to be inserted into the receiver and retains the appending member within the receiver after insertion.

28. The integrated sash lock and tilt-latch assembly of claim 27, wherein the connecting member has a ramped surface extending toward the flexible tab to assist insertion of the appending member into the receiver.

29. The integrated sash lock and tilt-latch assembly of claim 26, wherein the appending member has a hook thereon, wherein the hook is received in the receiver of the connecting member.

30. The integrated sash lock and tilt-latch assembly of claim 24, wherein the connecting member has a flexible arm at least partially defining the passage, wherein the flexible arm flexes to permit insertion of the connector into the passage.

31. The integrated sash lock and tilt-latch assembly of claim 30, wherein the flexible arm has a locking tab thereon, wherein the locking tab engages the connector to retain the connector within the passage after insertion.

32. The integrated sash lock and tilt-latch assembly of claim 30, wherein the connecting member has a plurality of flexible arms at least partially defining the passage, wherein the flexible arms flex to permit insertion of the connector into the passage.

33. The integrated sash lock and tilt-latch assembly of claim 32, wherein at least two of the flexible arms are positioned in opposed relation to each other, on opposite sides of the passage, to engage the connector in a clamping configuration.

34. The integrated sash lock and tilt-latch assembly of claim 32, wherein each of the flexible arms has a locking tab thereon, wherein the locking tabs engage the connector to retain the connector within the passage after insertion.

35. The integrated sash lock and tilt-latch assembly of claim 24, wherein the connecting member has a plurality of teeth extending into the passage, and the connector has a plurality of teeth disposed along at least a portion of the connector, and wherein the teeth of the connecting member engage the teeth of the connector to retain the connector within the passage.

36. An integrated sash lock and tilt-latch assembly for a sash window assembly, the sash window assembly having a lower sash window having a top rail, a bottom rail, and a pair of stiles and an upper sash window having a keeper, the integrated assembly comprising:
a sash lock mechanism adapted to be supported by the top rail, comprising:
a handle;
a sash lock housing adapted to be supported on a top surface of the top rail, the sash lock housing having an opening receiving the handle therethrough;
a rotor coupled to the handle and being rotatable by movement of the handle; and
a pawl operably connected to the rotor, wherein the rotor and the pawl rotate in unison over a portion of the range of rotation of the rotor, the pawl comprising a base and an appending member extending from the base;
a first tilt-latch mechanism adapted to be supported by the lower sash window and comprising a latch bolt slidably supported by the lower sash window and moveable between an extended position and a retracted position;
a second tilt-latch mechanism adapted to be supported by the lower sash window and comprising a latch bolt slidably supported by the lower sash window and moveable between an extended position and a retracted position;
a first connector having an end operably connected to the latch bolt of the first tilt-latch mechanism, the first connector having a plurality of teeth extending along at least a portion of a length of the first connector;
a connection member connecting the pawl to the first connector, the connection member having a passage receiving a portion of the connector therethrough and a receiver to receive the appending member of the pawl;
a second connector having an end operably connected to the latch bolt of the second tilt-latch mechanism, the second connector having a plurality of teeth extending along at least a portion of a length of the second connector; and
a drive mechanism operably connecting the first connector and the second connector such that movement of the first connector creates reciprocal movement of the second connector, the drive mechanism comprising a pinion housing mounted to the sash lock housing and a pinion gear rotatably mounted inside the pinion housing, the pinion gear having a plurality of gear teeth engaged with the teeth of the first connector and the teeth of the second connector, wherein movement of the first connector causes rotation of the pinion gear, and rotation of the pinion gear causes movement of the second connector,
wherein the rotor is moveable among a locked position, an unlocked position and a tiltable position, wherein the rotor is adapted to engage the keeper in the locked position, wherein the rotor is adapted to be disengaged from the keeper in the unlocked position, and wherein when the rotor is moved to the tiltable position, the rotor and the pawl rotate in unison to move the first connector to move the latch bolt of the first tilt-latch mechanism to the retracted position, and the drive mechanism moves the second connector to move the latch bolt of the second tilt-latch mechanism to the retracted position.
